(19) United States
(12) Patent Application Publication
(10) Pub. No.: US 2025/0024872 A1
(43) Pub. Date: Jan. 23, 2025

(54) SALTY TASTE ENHANCER

(71) Applicant: AJINOMOTO CO., INC., Tokyo (JP)

(72) Inventors: Yoshimasa MIURA, Kawasaki-shi (JP); Kyoko KANNO, Kawasaki-shi (JP); Seiji KITAJIMA, Kawasaki-shi (JP); Koji SHIMOSUKA, Kawasaki-shi (JP)

(73) Assignee: AJINOMOTO CO., INC., Tokyo (JP)

(21) Appl. No.: 18/898,085

(22) Filed: Sep. 26, 2024

Related U.S. Application Data
(63) Continuation of application No. PCT/JP2023/012591, filed on Mar. 28, 2023.

(30) Foreign Application Priority Data
Mar. 28, 2022 (JP) 2022-052563

(51) Int. Cl. A23L 27/00; A23L 27/20

(52) U.S. Cl. CPC A23L 27/88; A23L 27/2028; A23L 27/204

(57) ABSTRACT

Saltiness enhancers containing cyclotene as an active ingredient can effectively enhance the saltiness of a sodium chloride-containing food.

### CROSS REFERENCES TO RELATED APPLICATIONS

This application is a continuation of International Patent Application No. PCT/JP2023/012591, filed on Mar. 28, 2023, and claims priority to Japanese Patent Application No. 2022-052563, filed on Mar. 28, 2022, both of which are incorporated herein by reference in their entireties.

### BACKGROUND OF THE INVENTION

### Field of the Invention

The present invention relates to saltiness enhancers. The present invention also relates to methods for enhancing a saltiness of sodium chloride-containing foods. Furthermore, the present invention relates to sodium chloride-containing foods and production methods thereof.

### Discussion of the Background

Sodium chloride can be used in foods for various purposes such as adding a saltiness and the like. Since excessive intake of sodium chloride increases the risk of causing hypertension, cardiac disease and the like, and because of the recent health consciousness, it is considered important to reduce the amount of sodium chloride intake. The amount of sodium chloride intake can be reduced by reducing the amount of sodium chloride used (sodium chloride reduction) when manufacturing food. Such sodium chloride-reduced food has a problem that the shortage of saltiness leads to less satisfaction. Therefore, there is a demand for the development of a technique for enhancing the saltiness of foods without increasing the amount of sodium chloride intake.

On the other hand, it has been reported that by adding cyclotene to sweet sake (mirin) in a specific amount or more, mirin can be obtained that has both first taste and after taste and has a quality of sake with enhanced thickness and longevity of sweetness (JP 2018-68293 A, which is incorporated herein by reference in its entirety). However, J P 2018-68293 A does not state that cyclotene has a saltiness enhancing effect.

It has also been reported that the taste can be enhanced by adding 3, 4-dimethyl-5-propylidenefuran-2 (5H)-one to food (JP 2019-37204 A, which is incorporated herein by reference in its entirety). JP 2019-37204 A lists cyclotene and the like as examples of flavor compounds that can be combined with 3,4-dimethyl-5-propylidenefuran-2 (5H)-one, but does not describe that the taste enhancing effect of cyclotene has been experimentally confirmed.

### SUMMARY OF THE INVENTION

The present invention has been made in consideration of the above-mentioned circumstances, and it is an object of the present invention to provide a novel saltiness enhancer and a method for enhancing the saltiness that can effectively enhance the saltiness of sodium chloride-containing foods, sodium chloride-containing foods with enhanced saltiness and production methods thereof, and the like.

This and other objects, which will become apparent during the following detailed description, have been achieved by the present inventors' discovery that cyclotene has a saltiness enhancing action. The present inventors have conducted further studies and found that a saltiness can be enhanced more effectively by using 4-methylpentanoic acid or a salt thereof, and/or aliphatic monocarboxylic acid or a salt thereof in combination. The present inventors have conducted further studies based on these findings and completed the present invention.

Accordingly, the present invention provides the following.
(1) A saltiness enhancer comprising (A) cyclotene as an active ingredient.
(2) The enhancer of (1), wherein the enhancer is added to a sodium chloride-containing food such that the amount of the aforementioned (A) to be added to the sodium chloride-containing food is 0.005 to 500000 weight ppb with respect to the total weight of the sodium chloride-containing food.
(3) The enhancer of (1), further comprising (B) 4-methylpentanoic acid or a salt thereof, and/or (C) aliphatic monocarboxylic acid having a carbon atom number of 4 to 16 or a salt thereof as the active ingredient.
(4) The enhancer of (3), wherein the aforementioned (C) is at least one selected from the group consisting of octanoic acid, nonanoic acid, decanoic acid, undecanoic acid, dodecanoic acid and salts thereof.
(5) The enhancer of (3), wherein the aforementioned (C) is at least one selected from the group consisting of octanoic acid, decanoic acid, undecanoic acid and salts thereof.
(6) The enhancer of (3), wherein the aforementioned (C) is decanoic acid or a salt thereof.
(7) The enhancer of (3), wherein the active ingredients are the aforementioned (A) and (B),
   the enhancer is added to a sodium chloride-containing food such that the amount of the aforementioned (A) to be added to the sodium chloride-containing food is 0.0005 to 500000 weight ppb with respect to the total weight of the sodium chloride-containing food, and
   the amount of the aforementioned (B) to be added to the sodium chloride-containing food is 0.00005 to 500000 weight ppb with respect to the total weight of the sodium chloride-containing food.
(8) The enhancer of (3) or (7), wherein the active ingredients are the aforementioned (A) and (B), and a weight ratio of the content of the aforementioned (A) and the content of the aforementioned (B) (A:B) is 1:0.0025 to 750.
(9) The enhancer of any one of (3) to (6), wherein the active ingredients are the aforementioned (A) and (C),
   the enhancer is added to a sodium chloride-containing food such that the amount of the aforementioned (A) to be added to the sodium chloride-containing food is 0.0005 to 500000 weight ppb with respect to the total weight of the sodium chloride-containing food, and
   the amount of the aforementioned (C) to be added to the sodium chloride-containing food is 0.00005 to 500000 weight ppb with respect to the total weight of the sodium chloride-containing food.
(10) The enhancer of any one of (3) to (5) and (9), wherein the active ingredients are the aforementioned (A) and (C), (C) comprises octanoic acid,
   the enhancer is added to the sodium chloride-containing food such that the amount of the aforementioned (A) to be added to the sodium chloride-containing food is 0.0005 to 500000 weight ppb with respect to the total weight of the sodium chloride-containing food, and
   the amount of the octanoic acid to be added to the sodium chloride-containing food is 0.00005 to 500000 weight ppb with respect to the total weight of the sodium chloride-containing food.
(11) The enhancer of any one of (3), (4), (9) and (10), wherein the active ingredients are the aforementioned (A) and (C), (C) comprises nonanoic acid,
   the enhancer is added to the sodium chloride-containing food such that the amount of the aforementioned (A) to be added to the sodium chloride-containing food is 0.0005 to 500000 weight ppb with respect to the total weight of the sodium chloride-containing food, and
   the amount of the nonanoic acid to be added to the sodium chloride-containing is 0.00005 to 500000 weight ppb with respect to the total weight of the sodium chloride-containing food.
(12) The enhancer of any one of (3) to (6) and (9) to (11), wherein the active ingredients are the aforementioned (A) and (C), (C) comprises decanoic acid,
   the enhancer is added to the sodium chloride-containing food such that the amount of the aforementioned (A) to be added to the sodium chloride-containing food is 0.0005 to 500000 weight ppb with respect to the total weight of the sodium chloride-containing food, and
   the amount of the decanoic acid to be added to the sodium chloride-containing food is 0.00005 to 500000 weight ppb with respect to the total weight of the sodium chloride-containing food.
(13) The enhancer of any one of (3) to (5) and (9) to (12), wherein the active ingredients are the aforementioned (A) and (C), (C) comprises undecanoic acid,
   the enhancer is added to the sodium chloride-containing food such that the amount of the aforementioned (A) to be added to the sodium chloride-containing food is 0.0005 to 500000 weight ppb with respect to the total weight of the sodium chloride-containing food, and
   the amount of the undecanoic acid to be added to the sodium chloride-containing food is 0.00005 to 500000 weight ppb with respect to the total weight of the sodium chloride-containing food.
(14) The enhancer of any one of (3), (4) and (9) to (13), wherein the active ingredients are the aforementioned (A) and (C), (C) comprises dodecanoic acid,
   the enhancer is added to the sodium chloride-containing food such that the amount of the aforementioned (A) to be added to the sodium chloride-containing food is 0.0005 to 500000 weight ppb with respect to the total weight of the sodium chloride-containing food, and
   the amount of the dodecanoic acid to be added to the sodium chloride-containing food is 0.00005 to 500000 weight ppb with respect to the total weight of the sodium chloride-containing food.
(15) The enhancer of any one of (3) to (6) and (9) to (14), wherein the active ingredients are the aforementioned (A) and (C), and a weight ratio of the content of the aforementioned

(A) and the content of the aforementioned (C) (A:C) is 1:0.25 to 750000.
(16) The enhancer of any one of (3) to (5) and (9) to (15), wherein the active ingredients are the aforementioned (A) and (C), (C) comprises octanoic acid, and a weight ratio of the content of the aforementioned (A) and the content of octanoic acid (A: octanoic acid) is 1:25 to 75000.
(17) The enhancer of any one of (3), (4) and (9) to (16), wherein the active ingredients are the aforementioned (A) and (C), (C) comprises nonanoic acid, and
   a weight ratio of the content of the aforementioned (A) and the content of the nonanoic acid (A: nonanoic acid) is 1:0.25 to 750000.
(18) The enhancer of any one of (3) to (6) and (9) to (17), wherein the active ingredients are the aforementioned (A) and (C), (C) comprises decanoic acid, and
   a weight ratio of the content of the aforementioned (A) and the content of the decanoic acid (A: decanoic acid) is 1:0.25 to 750000.
(19) The enhancer of any one of (3) to (5) and (9) to (18), wherein the active ingredients are the aforementioned (A) and (C), (C) comprises undecanoic acid, and
   a weight ratio of the content of the aforementioned (A) and the content of the undecanoic acid (A: undecanoic acid) is 1:2500 to 75000.
(20) The enhancer of any one of (3), (4) and (9) to (19), wherein the active ingredients are the aforementioned (A) and (C), (C) comprises dodecanoic acid, and
   a weight ratio of the content of the aforementioned (A) and the content of the dodecanoic acid (A: dodecanoic acid) is 1:0.25 to 750.
(21) The enhancer of any one of (3) to (6), wherein the active ingredients are the aforementioned (A), (B) and (C),
   the enhancer is added to a sodium chloride-containing food such that the amount of the aforementioned (A) to be added to the sodium chloride-containing food is 0.0005 to 500000 weight ppb with respect to the total weight of the sodium chloride-containing food,
   the amount of the aforementioned (B) to be added to the sodium chloride-containing food is 0.00005 to 500000 weight ppb with respect to the total weight of the sodium chloride-containing food, and
   the amount of the aforementioned (C) to be added to the sodium chloride-containing food is 0.00005 to 500000 weight ppb with respect to the total weight of the sodium chloride-containing food.
(22) The enhancer of any one of (3) to (5) and (21), wherein the active ingredients are the aforementioned (A), (B) and (C), (C) comprises octanoic acid,
   the enhancer is added to the sodium chloride-containing food such that the amount of the aforementioned (A) to be added to the sodium chloride-containing food is 0.0005 to 500000 weight ppb with respect to the total weight of the sodium chloride-containing food,
   the amount of the aforementioned (B) to be added to the sodium chloride-containing food is 0.00005 to 500000 weight ppb with respect to the total weight of the sodium chloride-containing food, and
   the amount of the octanoic acid to be added to the sodium chloride-containing food is 0.00005 to 500000 weight ppb with respect to the total weight of the sodium chloride-containing food.
(23) The enhancer of any one of (3), (4), (21) and (22), wherein the active ingredients are the aforementioned (A), (B) and (C), (C) comprises nonanoic acid,
   the enhancer is added to the sodium chloride-containing food such that the amount of the aforementioned (A) to be added to the sodium chloride-containing food is 0.0005 to 500000 weight ppb with respect to the total weight of the sodium chloride-containing food,
   the amount of the aforementioned (B) to be added to the sodium chloride-containing food is 0.00005 to 500000 weight ppb with respect to the total weight of the sodium chloride-containing food, and
   the amount of the nonanoic acid to be added to the sodium chloride-containing food is 0.00005 to 500000 weight ppb with respect to the total weight of the sodium chloride-containing food.
(24) The enhancer of any one of (3) to (6) and (21) to (23), wherein the active ingredients are the aforementioned (A), (B) and (C), (C) comprises decanoic acid,
   the enhancer is added to the sodium chloride-containing food such that the amount of the aforementioned (A) to be added to the sodium chloride-containing food is 0.0005 to 500000 weight ppb with respect to the total weight of the sodium chloride-containing food,
   the amount of the aforementioned (B) to be added to the sodium chloride-containing food is 0.00005 to 500000 weight ppb with respect to the total weight of the sodium chloride-containing food, and
   the amount of the decanoic acid to be added to the sodium chloride-containing food is 0.00005 to 500000 weight ppb with respect to the total weight of the sodium chloride-containing food.
(25) The enhancer of any one of (3) to (5) and (21 to (24), wherein the active ingredients are the aforementioned (A), (B) and (C), (C) comprises undecanoic acid,
   the enhancer is added to the sodium chloride-containing food such that the amount of the aforementioned (A) to be added to the sodium chloride-containing food is 0.0005 to 500000 weight ppb with respect to the total weight of the sodium chloride-containing food,
   the amount of the aforementioned (B) to be added to the sodium chloride-containing food is 0.00005 to 500000 weight ppb with respect to the total weight of the sodium chloride-containing food, and
   the amount of the undecanoic acid to be added to the sodium chloride-containing food is 0.00005 to 500000 weight ppb with respect to the total weight of the sodium chloride-containing food.
(26) The enhancer of any one of (3), (4) and (21) to (25), wherein the active ingredients are the aforementioned (A), (B) and (C), (C) comprises dodecanoic acid,
   the enhancer is added to the sodium chloride-containing food such that the amount of the aforementioned (A) to be added to the sodium chloride-containing food is 0.0005 to 500000 weight ppb with respect to the total weight of the sodium chloride-containing food,
   the amount of the aforementioned (B) to be added to the sodium chloride-containing food is 0.00005 to 500000 weight ppb with respect to the total weight of the sodium chloride-containing food, and
   the amount of the dodecanoic acid to be added to the sodium chloride-containing food is 0.00005 to 500000 weight ppb with respect to the total weight of the sodium chloride-containing food.
(27) The enhancer of any one of (3) to (6) and (21) to (26), wherein the active ingredients are the aforementioned (A), (B) and (C), and
   a weight ratio of the content of the aforementioned (A), the content of the aforementioned (B), and the content of the aforementioned (C) (A:B:C) is 1:0.025 to 7500:0.25 to 750000.
(28) The enhancer of any one of (3) to (5) and (21) to (27), wherein the active ingredients are the aforementioned (A), (B) and (C), (C) comprises octanoic acid, and
   a weight ratio of the content of the aforementioned (A), the content of the aforementioned (B), and the content of the octanoic acid (A:B:octanoic acid) is 1:0.25 to 750:0.25 to 7.5.
(29) The enhancer of any one of (3), (4) and (21) to (28), wherein the active ingredients are the aforementioned (A), (B) and (C), (C) comprises nonanoic acid, and
   a weight ratio of the content of the aforementioned (A), the content of the aforementioned (B), and the content of the nonanoic acid (A:B:nonanoic acid) is 1:0.25 to 750:0.025 to 0.75.
(30) The enhancer of any one of (3) to (6) and (21) to (29), wherein the active ingredients are the aforementioned (A), (B) and (C), (C) comprises decanoic acid, and
   a weight ratio of the content of the aforementioned (A), the content of the aforementioned (B), and the content of the decanoic acid (A:B:decanoic acid) is 1:0.0025 to 7500:0.25 to 750000.
(31) The enhancer of any one of (3) to (5) and (21) to (30), wherein the active ingredients are the aforementioned (A), (B) and (C), (C) comprises undecanoic acid, and
   a weight ratio of the content of the aforementioned (A), the content of the aforementioned (B), and the content of the undecanoic acid (A:B:undecanoic acid) is 1:0.25 to 75:0.0025 to 0.075.
(32) The enhancer of any one of (3), (4) and (21) to (31), wherein the active ingredients are the aforementioned (A), (B) and (C), (C) comprises dodecanoic acid, and
   a weight ratio of the content of the aforementioned (A), the content of the aforementioned (B), and the content of the dodecanoic acid (A:B:dodecanoic acid) is 1:0.25 to 750:0.025 to 0.75.
(33) A sodium chloride-containing food comprising the enhancer of any one of (1) to (32).
(34) A method for producing a sodium chloride-containing food, comprising adding (A) cyclotene.
(35) The production method of (34), wherein the amount of the aforementioned (A) to be added to the sodium chloride-containing food is 0.005 to 500000 weight ppb with respect to the total weight of the sodium chloride-containing food.
(36) The production method of (34), further comprising adding (B) 4-methylpentanoic acid or a salt thereof, and/or (C) aliphatic monocarboxylic acid having a carbon atom number of 4 to 16 or a salt thereof.
(37) The production method of (36), wherein the aforementioned (C) is at least one selected from the group consisting of octanoic acid, nonanoic acid, decanoic acid, undecanoic acid, dodecanoic acid and salts thereof.
(38) The production method of (36), wherein the aforementioned (C) is at least one selected from the group consisting of octanoic acid, decanoic acid, undecanoic acid and salts thereof.
(39) The production method of (36), wherein the aforementioned (C) is decanoic acid or a salt thereof.
(40) The production method of (36), comprising adding the aforementioned (A) and (B), wherein
   the amount of the aforementioned (A) to be added to the sodium chloride-containing food is 0.0005 to 500000 weight ppb with respect to the total weight of the sodium chloride-containing food, and
   the amount of the aforementioned (B) to be added to the sodium chloride-containing food is 0.00005 to 500000 weight ppb with respect to the total weight of the sodium chloride-containing food.
(41) The production method of (36), comprising adding the aforementioned (A) and (B), wherein
   a weight ratio of the content of the aforementioned (A) and the content of the aforementioned (B) to be added to the sodium chloride-containing food (A:B) is 1:0.0025 to 750.
(42) The production method of any one of (36) to (39), comprising adding the aforementioned (A) and (C), wherein
   the amount of the aforementioned (A) to be added to the sodium chloride-containing food is 0.0005 to 500000 weight ppb with respect to the total weight of the sodium chloride-containing food, and
   the amount of the aforementioned (C) to be added to the sodium chloride-containing food is 0.00005 to 500000 weight ppb with respect to the total weight of the sodium chloride-containing food.
(43) The production method of any one of (36) to (38) and (42), comprising adding the aforementioned (A) and (C), wherein (C) comprises octanoic acid,
   the amount of the aforementioned (A) to be added to the sodium chloride-containing food is 0.0005 to 500000 weight ppb with respect to the total weight of the sodium chloride-containing food, and
   the amount of the octanoic acid to be added to the sodium chloride-containing food is 0.00005 to 500000 weight ppb with respect to the total weight of the sodium chloride-containing food.
(44) The production method of any one of (36), (37), (42) and (43), comprising adding the aforementioned (A) and (C), wherein (C) comprises nonanoic acid,
   the amount of the aforementioned (A) to be added to the sodium chloride-containing food is 0.0005 to 500000 weight ppb with respect to the total weight of the sodium chloride-containing food, and
   the amount of the nonanoic acid to be added to the sodium chloride-containing food is 0.00005 to 500000 weight ppb with respect to the total weight of the sodium chloride-containing food.
(45) The production method of any one of (36) to (39) and (42) to (44), comprising adding the aforementioned (A) and (C), wherein (C) comprises decanoic acid,
   the amount of the aforementioned (A) to be added to the sodium chloride-containing food is 0.0005 to 500000 weight ppb with respect to the total weight of the sodium chloride-containing food, and
   the amount of the decanoic acid to be added to the sodium chloride-containing food is 0.00005 to 500000 weight ppb with respect to the total weight of the sodium chloride-containing food.
(46) The production method of any one of (36) to (38) and (42) to (45), comprising adding the aforementioned (A) and (C), wherein (C) comprises undecanoic acid,
   the amount of the aforementioned (A) to be added to the sodium chloride-containing food is 0.0005 to 500000 weight ppb with respect to the total weight of the sodium chloride-containing food, and
   the amount of the undecanoic acid to be added to the sodium chloride-containing food is 0.00005 to 500000 weight ppb with respect to the total weight of the sodium chloride-containing food.
(47) The production method of any one of (36), (37) and (42) to (46), comprising adding the aforementioned (A) and (C), wherein (C) comprises dodecanoic acid,
   the amount of the aforementioned (A) to be added to the sodium chloride-containing food is 0.0005 to 500000 weight ppb with respect to the total weight of the sodium chloride-containing food, and
   the amount of the dodecanoic acid to be added to the sodium chloride-containing food is 0.00005 to 500000 weight ppb with respect to the total weight of the sodium chloride-containing food.
(48) The production method of any one of (36) to (39) and (42) to (47), comprising adding the aforementioned (A) and (C), wherein
   a weight ratio of the amount of the aforementioned (A) and the amount of the aforementioned (C) to be added to the sodium chloride-containing food (A:C) is 1:0.25 to 750000.
(49) The production method of any one of (36) to (38) and (42) to (48), comprising adding the aforementioned (A) and (C), wherein (C) comprises octanoic acid, and
   a weight ratio of the amount of the aforementioned (A) and the amount of the octanoic acid to be added to the sodium chloride-containing food (A: octanoic acid) is 1:25 to 75000.
(50) The production method of any one of (36), (37) and (42) to (49), comprising adding the aforementioned (A) and (C), wherein (C) comprises nonanoic acid, and
   a weight ratio of the amount of the aforementioned (A) and the amount of the nonanoic acid to be added to the sodium chloride-containing food (A: nonanoic acid) is 1:0.25 to 750000.
(51) The production method of any one of (36) to (39) and (42) to (50), comprising adding the aforementioned (A) and (C), wherein (C) comprises decanoic acid, and
   a weight ratio of the amount of the aforementioned (A) and the amount of the decanoic acid to be added to the sodium chloride-containing food (A: decanoic acid) is 1:0.25 to 750000.
(52) The production method of any one of (36) to (38) and (42) to (51), comprising adding the aforementioned (A) and (C), wherein (C) comprises undecanoic acid, and
   a weight ratio of the amount of the aforementioned (A) and the amount of the undecanoic acid to be added to the sodium chloride-containing food (A: undecanoic acid) is 1:2500 to 75000.
(53) The production method of any one of (36), (37) and (42) to (52), comprising adding the aforementioned (A) and (C), wherein (C) comprises dodecanoic acid, and
   a weight ratio of the amount of the aforementioned (A) and the amount of the dodecanoic acid to be added to the sodium chloride-containing food (A: dodecanoic acid) is 1:0.25 to 750.
(54) The production method of any one of (36) to (39), comprising adding the aforementioned (A), (B) and (C), wherein
   the amount of the aforementioned (A) to be added to the sodium chloride-containing food is 0.0005 to 500000 weight ppb with respect to the total weight of the sodium chloride-containing food, and
   the amount of the aforementioned (B) to be added to the sodium chloride-containing food is 0.00005 to 500000 weight ppb with respect to the total weight of the sodium chloride-containing food, and
   the amount of the aforementioned (C) to be added to the sodium chloride-containing food is 0.00005 to 500000 weight ppb with respect to the total weight of the sodium chloride-containing food.
(55) The production method of any one of (36) to (38) and (54), comprising adding the aforementioned (A), (B) and (C), wherein (C) comprises octanoic acid,
   the amount of the aforementioned (A) to be added to the sodium chloride-containing food is 0.0005 to 500000 weight ppb with respect to the total weight of the sodium chloride-containing food, and
   the amount of the aforementioned (B) to be added to the sodium chloride-containing food is 0.00005 to 500000 weight ppb with respect to the total weight of the sodium chloride-containing food, and
   the amount of the octanoic acid to be added to the sodium chloride-containing food is 0.00005 to 500000 weight ppb with respect to the total weight of the sodium chloride-containing food.
(56) The production method of any one of (36), (37), (54) and (55), comprising adding the aforementioned (A), (B) and (C), wherein (C) comprises nonanoic acid,
   the amount of the aforementioned (A) to be added to the sodium chloride-containing food is 0.0005 to 500000 weight ppb with respect to the total weight of the sodium chloride-containing food, and
   the amount of the aforementioned (B) to be added to the sodium chloride-containing food is 0.00005 to 500000 weight ppb with respect to the total weight of the sodium chloride-containing food, and
   the amount of the nonanoic acid to be added to the sodium chloride-containing food is 0.00005 to 500000 weight ppb with respect to the total weight of the sodium chloride-containing food.
(57) The production method of any one of (36) to (39) and (54) to (56), comprising adding the aforementioned (A), (B) and (C), wherein (C) comprises decanoic acid,
   the amount of the aforementioned (A) to be added to the sodium chloride-containing food is 0.0005 to 500000 weight ppb with respect to the total weight of the sodium chloride-containing food, and
   the amount of the aforementioned (B) to be added to the sodium chloride-containing food is 0.00005 to 500000 weight ppb with respect to the total weight of the sodium chloride-containing food, and
   the amount of the decanoic acid to be added to the sodium chloride-containing food is 0.00005 to 500000 weight ppb with respect to the total weight of the sodium chloride-containing food.
(58) The production method of any one of (36) to (38) and (54) to (57), comprising adding the aforementioned (A), (B) and (C), wherein (C) comprises undecanoic acid,
   the amount of the aforementioned (A) to be added to the sodium chloride-containing food is 0.0005 to 500000 weight ppb with respect to the total weight of the sodium chloride-containing food, and
   the amount of the aforementioned (B) to be added to the sodium chloride-containing food is 0.00005 to 500000 weight ppb with respect to the total weight of the sodium chloride-containing food, and
   the amount of the undecanoic acid to be added to the sodium chloride-containing food is 0.00005 to 500000 weight ppb with respect to the total weight of the sodium chloride-containing food.
(59) The production method of any one of (36), (37) and (54) to (58), comprising adding the aforementioned (A), (B) and (C), wherein (C) comprises dodecanoic acid,
   the amount of the aforementioned (A) to be added to the sodium chloride-containing food is 0.0005 to 500000 weight ppb with respect to the total weight of the sodium chloride-containing food, and
   the amount of the aforementioned (B) to be added to the sodium chloride-containing food is 0.00005 to 500000 weight ppb with respect to the total weight of the sodium chloride-containing food, and
   the amount of the dodecanoic acid to be added to the sodium chloride-containing food is 0.00005 to 500000 weight ppb with respect to the total weight of the sodium chloride-containing food.
(60) The production method of any one of (36) to (39) and (54) to (59), comprising adding the aforementioned (A), (B) and (C), wherein
   a weight ratio of the amount of the aforementioned (A), the amount of the aforementioned (B), and the amount of the aforementioned (C) to be added to the sodium chloride-containing food (A:B:C) is 1:0.025 to 7500:0.25 to 750000.
(61) The production method of any one of (36) to (38) and (54) to (60), comprising adding the aforementioned (A), (B) and (C), wherein (C) comprises octanoic acid, and
   a weight ratio of the amount of the aforementioned (A), the amount of the aforementioned (B), and the amount of the octanoic acid to be added to the sodium chloride-containing food (A:B:octanoic acid) is 1:0.25 to 750:0.25 to 7.5.
(62) The production method of any one of (36), (37) and (54) to (61), comprising adding the aforementioned (A), (B) and (C), wherein (C) comprises nonanoic acid, and
   a weight ratio of the amount of the aforementioned (A), the amount of the aforementioned (B), and the amount of the nonanoic acid to be added to the sodium chloride-containing food (A:B:nonanoic acid) is 1:0.25 to 750:0.025 to 0.75.
(63) The production method of any one of (36) to (39) and (54) to (62), comprising adding the aforementioned (A), (B) and (C), wherein (C) comprises decanoic acid, and
   the amount of the aforementioned (B), and the amount of the decanoic acid to be added to the sodium chloride-containing food (A:B:decanoic acid) is 1:0.0025 to 7500:0.25 to 750000.
(64) The production method of any one of (36) to (38) and (54) to (63), comprising adding the aforementioned (A), (B) and (C), wherein (C) comprises undecanoic acid, and
   a weight ratio of the amount of the aforementioned (A), the amount of the aforementioned (B), and the amount of the undecanoic acid to be added to the sodium chloride-containing food (A:B:undecanoic acid) is 1:0.25 to 75:0.0025 to 0.075.
(65) The production method of any one of (36), (37) and (54) to (64), comprising adding the aforementioned (A), (B) and (C), wherein (C) comprises dodecanoic acid, and
   a weight ratio of the amount of the aforementioned (A), the amount of the aforementioned (B), and the amount of the dodecanoic acid to be added to the sodium chloride-containing food (A:B:dodecanoic acid) is 1:0.25 to 750:0.025 to 0.75.
(66) A method for enhancing a saltiness of a sodium chloride-containing food, comprising adding (A) cyclotene.
(67) The enhancement method of (66), wherein the amount of the aforementioned (A) to be added to the sodium chloride-containing food is 0.005 to 500000 weight ppb with respect to the total weight of the sodium chloride-containing food.
(68) The enhancement method of (66), further comprising adding (B) 4-methylpentanoic acid or a salt thereof, and/or (C) aliphatic monocarboxylic acid having a carbon atom number of 4 to 16 or a salt thereof.
(69) The enhancement method of (68), wherein the aforementioned (C) is at least one selected from the group consisting of octanoic acid, nonanoic acid, decanoic acid, undecanoic acid, dodecanoic acid and salts thereof.
(70) The enhancement method of (68), wherein the aforementioned (C) is at least one selected from the group consisting of octanoic acid, decanoic acid, undecanoic acid and salts thereof.
(71) The enhancement method of (68), wherein the aforementioned (C) is decanoic acid or a salt thereof.
(72) The enhancement method of (68), comprising adding the aforementioned (A) and (B), wherein
   the amount of the aforementioned (A) to be added to the sodium chloride-containing food is 0.0005 to 500000 weight ppb with respect to the total weight of the sodium chloride-containing food, and
   the amount of the aforementioned (B) to be added to the sodium chloride-containing food is 0.00005 to 500000 weight ppb with respect to the total weight of the sodium chloride-containing food.
(73) The enhancement method of (72), comprising adding the aforementioned (A) and (B), wherein
   a weight ratio of the content of the aforementioned (A) and the content of the aforementioned (B) to be added to the sodium chloride-containing food (A:B) is 1:0.25 to 750.
(74) The enhancement method of (38), comprising adding the aforementioned (A) and (C), wherein
   the amount of the aforementioned (A) to be added to the sodium chloride-containing food is 0.0005 to 500000 weight ppb with respect to the total weight of the sodium chloride-containing food, and
   the amount of the aforementioned (C) to be added to the sodium chloride-containing food is 0.00005 to 500000 weight ppb with respect to the total weight of the sodium chloride-containing food.
(75) The enhancement method of any one of (68) to (70) and (74), comprising adding the aforementioned (A) and (C), wherein (C) comprises octanoic acid,
   the amount of the aforementioned (A) to be added to the sodium chloride-containing food is 0.0005 to 500000 weight ppb with respect to the total weight of the sodium chloride-containing food, and
   the amount of the octanoic acid to be added to the sodium chloride-containing food is 0.00005 to 500000 weight ppb with respect to the total weight of the sodium chloride-containing food.
(76) The enhancement method of any one of (68), (69), (74) and (75), comprising adding the aforementioned (A) and (C), wherein (C) comprises nonanoic acid,
   the amount of the aforementioned (A) to be added to the sodium chloride-containing food is 0.0005 to 500000 weight ppb with respect to the total weight of the sodium chloride-containing food, and
   the amount of the nonanoic acid to be added to the sodium chloride-containing food is 0.00005 to 500000 weight ppb with respect to the total weight of the sodium chloride-containing food.
(77) The enhancement method of any one of (68) to (71) and (74) to (76), comprising adding the aforementioned (A) and (C), wherein (C) comprises decanoic acid,
   the amount of the aforementioned (A) to be added to the sodium chloride-containing food is 0.0005 to 500000 weight ppb with respect to the total weight of the sodium chloride-containing food, and
   the amount of the decanoic acid to be added to the sodium chloride-containing food is 0.00005 to 500000 weight ppb with respect to the total weight of the sodium chloride-containing food.
(78) The enhancement method of any one of (68) to (70) and (74) to (77), comprising adding the aforementioned (A) and (C), wherein (C) comprises undecanoic acid,
   the amount of the aforementioned (A) to be added to the sodium chloride-containing food is 0.0005 to 500000 weight ppb with respect to the total weight of the sodium chloride-containing food, and
   the amount of the undecanoic acid to be added to the sodium chloride-containing food is 0.00005 to 500000 weight ppb with respect to the total weight of the sodium chloride-containing food.
(79) The enhancement method of any one of (68), (69) and (74) to (78), comprising adding the aforementioned (A) and (C), wherein (C) comprises dodecanoic acid,
   the amount of the aforementioned (A) to be added to the sodium chloride-containing food is 0.0005 to 500000 weight ppb with respect to the total weight of the sodium chloride-containing food, and
   the amount of the dodecanoic acid to be added to the sodium chloride-containing food is 0.00005 to 500000 weight ppb with respect to the total weight of the sodium chloride-containing food.
(80) The enhancement method of any one of (68) to (71) and (74) to (79), comprising adding the aforementioned (A) and (C), wherein
   a weight ratio of the amount of the aforementioned (A) and the amount of the aforementioned (C) to be added to the sodium chloride-containing food (A:C) is 1:0.25 to 750000.
(81) The enhancement method of any one of (68) to (70) and (74) to (80), comprising adding the aforementioned (A) and (C), wherein (C) comprises octanoic acid, and
   a weight ratio of the amount of the aforementioned (A) and the amount of the octanoic acid to be added to the sodium chloride-containing food (A: octanoic acid) is 1:25 to 75000.
(82) The enhancement method of any one of (68), (69) and (74) to (81), comprising adding the aforementioned (A) and (C), wherein (C) comprises nonanoic acid, and
   a weight ratio of the amount of the aforementioned (A) and the amount of the nonanoic acid to be added to the sodium chloride-containing food (A: nonanoic acid) is 1:0.25 to 750000.
(83) The enhancement method of any one of (68) to (71) and (74) to (82), comprising adding the aforementioned (A) and (C), wherein (C) comprises decanoic acid, and
   a weight ratio of the amount of the aforementioned (A) and the amount of the decanoic acid to be added to the sodium chloride-containing food (A: decanoic acid) is 1:0.25 to 750000.
(84) The enhancement method of any one of (68) to (70) and (74) to (83), comprising adding the aforementioned (A) and (C), wherein (C) comprises undecanoic acid, and
   a weight ratio of the amount of the aforementioned (A) and the amount of the undecanoic acid to be added to the sodium chloride-containing food (A: undecanoic acid) is 1:2500 to 75000.
(85) The enhancement method of any one of (68), (69) and (74) to (84), comprising adding the aforementioned (A) and (C), wherein (C) comprises dodecanoic acid, and
   a weight ratio of the amount of the aforementioned (A) and the amount of the dodecanoic acid to be added to the sodium chloride-containing food (A: dodecanoic acid) is 1:0.25 to 750.
(86) The enhancement method of any one of (68) to (71), comprising adding the aforementioned (A), (B) and (C), wherein
   the amount of the aforementioned (A) to be added to the sodium chloride-containing food is 0.0005 to 500000 weight ppb with respect to the total weight of the sodium chloride-containing food, and
   the amount of the aforementioned (B) to be added to the sodium chloride-containing food is 0.00005 to 500000 weight ppb with respect to the total weight of the sodium chloride-containing food, and
   the amount of the aforementioned (C) to be added to the sodium chloride-containing food is 0.00005 to 500000 weight ppb with respect to the total weight of the sodium chloride-containing food.
(87) The enhancement method of any one of (68) to (70) and (86), comprising adding the aforementioned (A), (B) and (C), wherein (C) comprises octanoic acid,
   the amount of the aforementioned (A) to be added to the sodium chloride-containing food is 0.0005 to 500000 weight ppb with respect to the total weight of the sodium chloride-containing food, and
   the amount of the aforementioned (B) to be added to the sodium chloride-containing food is 0.00005 to 500000 weight ppb with respect to the total weight of the sodium chloride-containing food, and
   the amount of the octanoic acid to be added to the sodium chloride-containing food is 0.00005 to 500000 weight ppb with respect to the total weight of the sodium chloride-containing food.
(88) The enhancement method of any one of (68), (69), (86) and (87), comprising adding the aforementioned (A), (B) and (C), wherein (C) comprises nonanoic acid,
   the amount of the aforementioned (A) to be added to the sodium chloride-containing food is 0.0005 to 500000 weight ppb with respect to the total weight of the sodium chloride-containing food, and
   the amount of the aforementioned (B) to be added to the sodium chloride-containing food is 0.00005 to 500000 weight ppb with respect to the total weight of the sodium chloride-containing food, and
   the amount of the nonanoic acid to be added to the sodium chloride-containing food is 0.00005 to 500000 weight ppb with respect to the total weight of the sodium chloride-containing food.
(89) The enhancement method of any one of (68) to (71) and (86) to (88), comprising adding the aforementioned (A), (B) and (C), wherein (C) comprises decanoic acid,
   the amount of the aforementioned (A) to be added to the sodium chloride-containing food is 0.0005 to 500000 weight ppb with respect to the total weight of the sodium chloride-containing food, and
   the amount of the aforementioned (B) to be added to the sodium chloride-containing food is 0.00005 to 500000 weight ppb with respect to the total weight of the sodium chloride-containing food, and
   the amount of the decanoic acid to be added to the sodium chloride-containing food is 0.00005 to 500000 weight ppb with respect to the total weight of the sodium chloride-containing food.
(90) The enhancement method of any one of (68) to (70) and (86) to (89), comprising adding the aforementioned (A), (B) and (C), wherein (C) comprises undecanoic acid,
   the amount of the aforementioned (A) to be added to the sodium chloride-containing food is 0.0005 to 500000 weight ppb with respect to the total weight of the sodium chloride-containing food, and
   the amount of the aforementioned (B) to be added to the sodium chloride-containing food is 0.00005 to 500000 weight ppb with respect to the total weight of the sodium chloride-containing food, and
   the amount of the undecanoic acid to be added to the sodium chloride-containing food is 0.00005 to 500000 weight ppb with respect to the total weight of the sodium chloride-containing food.
(91) The enhancement method of any one of (68), (69) and (86) to (90), comprising adding the aforementioned (A), (B) and (C), wherein (C) comprises dodecanoic acid,
   the amount of the aforementioned (A) to be added to the sodium chloride-containing food is 0.0005 to 500000 weight ppb with respect to the total weight of the sodium chloride-containing food, and
   the amount of the aforementioned (B) to be added to the sodium chloride-containing food is 0.00005 to 500000 weight ppb with respect to the total weight of the sodium chloride-containing food, and
   the amount of the dodecanoic acid to be added to the sodium chloride-containing food is 0.00005 to 500000 weight ppb with respect to the total weight of the sodium chloride-containing food.
(92) The enhancement method of any one of (68) to (71) and (86) to (91), comprising adding the aforementioned (A), (B) and (C), wherein
   a weight ratio of the amount of the aforementioned (A) the amount of the aforementioned (B), and the amount of the aforementioned (C) to be added to the sodium chloride-containing food (A:B:C) is 1:0.025 to 7500:0.25 to 750000.
(93) The enhancement method of any one of (68) to (70) and (86) to (92), comprising adding the aforementioned (A), (B) and (C), wherein (C) comprises octanoic acid, and
   a weight ratio of the amount of the aforementioned (A), the amount of the aforementioned (B), and the amount of the octanoic acid to be added to the sodium chloride-containing food (A:B:octanoic acid) is 1:0.25 to 750:0.25 to 7.5.
(94) The enhancement method of any one of (68), (69) and (86) to (93), comprising adding the aforementioned (A), (B) and (C), wherein (C) comprises nonanoic acid, and
   a weight ratio of the amount of the aforementioned (A), the amount of the aforementioned (B), and the amount of the nonanoic acid to be added to the sodium chloride-containing food (A:B:nonanoic acid) is 1:0.25 to 750:0.025 to 0.75.
(95) The enhancement method of any one of (68) to (71) and (86) to (94), comprising adding the aforementioned (A), (B) and (C), wherein (C) comprises decanoic acid, and
   a weight ratio of the amount of the aforementioned (A), the amount of the aforementioned (B), and the amount of the decanoic acid to be added to the sodium chloride-containing food (A:B:decanoic acid) is 1:0.0025 to 7500:0.25 to 750000.
(96) The enhancement method of any one of (68) to (70) and (86) to (95), comprising adding the aforementioned (A), (B) and (C), wherein (C) comprises undecanoic acid, and
   a weight ratio of the amount of the aforementioned (A), the amount of the aforementioned (B), and the amount of the undecanoic acid to be added to the sodium chloride-containing food (A:B:undecanoic acid) is 1:0.25 to 75:0.0025 to 0.075.
(97) The enhancement method of any one of (68), (69) and (86) to (96), comprising adding the aforementioned (A), (B) and (C), wherein (C) comprises dodecanoic acid, and
   a weight ratio of the amount of the aforementioned (A) the amount of the aforementioned (B), and the amount of the dodecanoic acid to be added to the sodium chloride-containing food (A:B:dodecanoic acid) is 1:0.25 to 750:0.025 to 0.75.
(98) A composition comprising (A) cyclotene, (B) 4-methylpentanoic acid or a salt thereof, and (C) aliphatic monocarboxylic acid having a carbon atom number of 4 to 16 or a salt thereof.
(99) The composition of (98), wherein the aforementioned (C) is at least one selected from the group consisting of octanoic acid, nonanoic acid, decanoic acid, undecanoic acid, dodecanoic acid and salts thereof.
(100) The composition of (98), wherein the aforementioned (C) is at least one selected from the group consisting of octanoic acid, decanoic acid, undecanoic acid and salts thereof.
(101) The composition of any one of (98) to (100), wherein
   the content of (A) in the aforementioned composition is 0.0001 to 99.9 wt % with respect to the aforementioned composition,
   the content of (B) in the aforementioned composition is 0.00001 to 90 wt % with respect to the aforementioned composition, and
   the content of (C) in the aforementioned composition is 0.00001 to 90 wt % with respect to the aforementioned composition.
(102) The composition of any one of (98) to (101), wherein a weight ratio of the content of (A), the content of (B), and the content of (C) (A:B:C) is 1:0.0025 to 7500:0.0025 to 750000.
(103) The composition of any one of (98) to (102), wherein
   the composition is added to the sodium chloride-containing food such that the amount of the aforementioned (A) to be added to the sodium chloride-containing food is 0.0005 to 500000 weight ppb with respect to the total weight of the sodium chloride-containing food,
   the amount of the aforementioned (B) to be added to the sodium chloride-containing food is 0.00005 to 500000 weight ppb with respect to the total weight of the sodium chloride-containing food, and
   the amount of the aforementioned (C) to be added to the sodium chloride-containing food is 0.00005 to 500000 weight ppb with respect to the total weight of the sodium chloride-containing food.

### Advantageous Effects of Invention

According to the present invention, a saltiness enhancer is provided. The enhancer of the present invention can enhance the saltiness of a sodium chloride-containing food. The enhancer of the present invention preferably can enhance the saltiness of a sodium chloride-containing food without imparting a smell.

In addition, according to the present invention, a method for enhancing the saltiness of a sodium chloride-containing food is provided. The enhancement method of the present invention can enhance the saltiness of a sodium chloride-containing food. The enhancement method of the present invention preferably can enhance the saltiness of a sodium chloride-containing food without imparting a smell.

In addition, according to the present invention, a method for producing a sodium chloride-containing food is provided. The production method of the present invention can produce a sodium chloride-containing food with an enhanced saltiness. The production method of the present invention preferably can produce a sodium chloride-containing food with an enhanced saltiness without imparting a smell.

### DETAILED DESCRIPTION OF THE PREFERRED EMBODIMENTS

### Saltiness Enhancer of the Present Invention

One of the characteristics of the saltiness enhancer of the present invention (sometimes to be referred to as “the enhancer of the present invention” in the present specification) is that it contains (A) cyclotene (sometimes to be simply referred to as “(A)” in the present specification) as an active ingredient.

Cyclotene to be used as (A) in the present invention is represented by the following formula and has a CAS Registry Number 80-71-7.

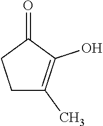

The method for producing (A) (i.e., cyclotene) to be used in the present invention is not particularly limited, and a compound produced by a method known per se (e.g., chemical synthesis method, enzyme method, fermentation method, extraction method, etc.) or a method analogous thereto may be used. A commercially available product may be used as (A).

One embodiment of (A) (i.e., cyclotene) to be used in the present invention may be a chemically synthesized product produced by a chemical synthesis method or an isolated product obtained by extraction and purification from a material containing (A). Examples of the material containing (A) include naturally occurring substances such as agricultural/livestock/aquatic products and the like; fermentation products such as culture medium, bacterial cells and the like obtained by culturing microorganisms; and processed products thereof, and the like.

In the present invention, a material containing (A) may be used as it is or purified to a desired degree and used in place of a chemically synthesized product or isolated product of (A), or in addition to the chemically synthesized product or isolated product. The content of (A) in the material can be measured by gas chromatography-mass spectrometry (GC-MS).

The content of (A) in the enhancer of the present invention is preferably 0.00001 wt % or more, more preferably 0.0001 wt % or more, further preferably 0.1 wt % or more, particularly preferably 1 wt % or more, with respect to the enhancer of the present invention. The content of (A) in the enhancer of the present invention may be 100 wt % or less, preferably 99.9 wt % or less, more preferably 90 wt % or less, particularly preferably 80 wt % or less, with respect to the enhancer of the present invention. For example, the content of (A) in the enhancer of the present invention is preferably 0.00001 to 100 wt %, more preferably 0.0001 to 99.9 wt %, further preferably 0.1 to 90 wt %, particularly preferably 1 to 80 wt %, with respect to the enhancer of the present invention.

The enhancer of the present invention can further contain, in addition to (A) (i.e., cyclotene), (B) 4-methylpentanoic acid or a salt thereof (sometimes to be simply referred to as “(B)” in the present specification), and/or (C) aliphatic monocarboxylic acid or a salt thereof (sometimes to be simply referred to as “(C)” in the present specification), as active ingredients.

4-Methylpentanoic acid used as (B) in the present invention is represented by the following formula and has a CAS Registry Number 646-07-1.

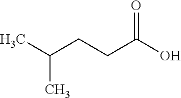

The salt of 4-methylpentanoic acid used as (B) in the present invention is not particularly limited as long as it is an edible salt and does not impair the purpose of the present invention. For example, salts with alkali metals such as sodium, potassium and the like; salts with alkaline earth metals such as calcium, magnesium and the like; ammonium salt; aluminum salt; zinc salt; salts with organic amines such as triethylamine, ethanolamine, morpholine, pyrrolidine, piperidine, piperazine, dicyclohexylamine and the like; salts with basic amino acids such as arginine, lysine and the like can be mentioned. These salts may be hydrates (hydrate salts) and examples of such hydrate include 1 to 6 hydrates and the like. Any one kind of these salts may be used alone, or two or more kinds may be used in combination.

The production method of (B) used in the present invention (i.e., 4-methylpentanoic acid or a salt thereof) is not particularly limited, and one produced by a method known per se (e.g., chemical synthesis method, enzyme method, fermentation method, extraction method, etc.) or a method analogous thereto may be used. A commercially available product may be used as (B).

One embodiment of (B) (i.e., 4-methylpentanoic acid or a salt thereof) used in the present invention may be a chemically synthesized product produced by a chemical synthesis method or an isolated product obtained by extraction and purification from a material containing (B). Examples of the material containing (B) include natural substances such as agricultural/livestock/aquatic products and the like; fermentation products such as culture medium, bacterial cells and the like obtained by culturing microorganisms; and processed products thereof, and the like.

In the present invention, a material containing (B) may be used as it is or purified to a desired degree and used in place of a chemically synthesized product or isolated product of (B), or in addition to the chemically synthesized product or isolated product. The content of (B) in the material can be measured by gas chromatography-mass spectrometry (GC-MS).

When the enhancer of the present invention contains at least (B) as an active ingredient in addition to (A), the content of (B) in the enhancer of the present invention is preferably 0.00001 wt % or more, more preferably 0.0001 wt % or more, further preferably 0.1 wt % or more, particularly preferably 1 wt % or more, with respect to the enhancer of the present invention. In this case, the content of (B) in the enhancer of the present invention is preferably 90 wt % or less, more preferably 80 wt % or less, further preferably 70 wt % or less, particularly preferably 50 wt % or less, with respect to the enhancer of the present invention. For example, when the enhancer of the present invention contains at least (B) as an active ingredient in addition to (A), the content of (B) in the enhancer of the present invention is preferably 0.00001 to 90 wt %, more preferably 0.0001 to 80 wt %, further preferably 0.1 to 70 wt %, particularly preferably 1 to 50 wt %, with respect to the enhancer of the present invention.

In the present specification, the content of (B) refers to, for example, the content of the one kind of (B) when the enhancer of the present invention contains only one kind of (B), and the total content of the two or more kinds of (B) when the enhancer of the present invention contains two or more kinds of (B). When (B) contains a salt of 4-methylpentanoic acid, the weight of the salt is converted to the weight of a free form.

When the enhancer of the present invention contains (B) as an active ingredient in addition to (A), a weight ratio of the content of the (A) and the content of (B) (A:B) in the enhancer of the present invention is preferably 1:0.25 to 750, more preferably 1:0.5 to 500, further preferably 1:0.6 to 300, particularly preferably 1:0.75 to 250, because a synergistic saltiness enhancing effect can be obtained. In one embodiment, the weight ratio (A:B) is preferably 1:0.0025 to 750, more preferably 1:0.005 to 500, further preferably 1:0.006 to 300, particularly preferably 1:0.0075 to 250, because a synergistic saltiness enhancing effect can be obtained.

The aliphatic monocarboxylic acid used as (C) in the present invention may be either saturated or unsaturated, preferably saturated. The aliphatic monocarboxylic acid may be linear or branched, and is preferably linear. The carbon atom number of the aliphatic monocarboxylic acid is preferably 4 to 16, more preferably 6 to 14, further preferably 7 to 13, particularly preferably 8 to 12.

Specific examples of (C) used in the present invention (i.e., aliphatic monocarboxylic acid) include butanoic acid, pentanoic acid, hexanoic acid, 2-methylpentanoic acid, 3-methylpentanoic acid, 4-methylpentanoic acid, heptanoic acid, 2-methylhexanoic acid, 5-methylhexanoic acid, octanoic acid, 2-methylheptanoic acid, nonanoic acid, 4-methyloctanoic acid, decanoic acid, 4-methylnonanoic acid, undecanoic acid, dodecanoic acid, tridecanoic acid, tetradecanoic acid, pentadecanoic acid, hexadecanoic acid and the like, preferably hexanoic acid, 2-methylpentanoic acid, 3-methylpentanoic acid, 4-methylpentanoic acid, heptanoic acid, 2-methylhexanoic acid, 5-methylhexanoic acid, octanoic acid, 2-methylheptanoic acid, nonanoic acid, 4-methyloctanoic acid, decanoic acid, 4-methylnonanoic acid, undecanoic acid, dodecanoic acid, tridecanoic acid, and tetradecanoic acid, more preferably octanoic acid, 2-methylheptanoic acid, nonanoic acid, 4-methyloctanoic acid, decanoic acid, 4-methylnonanoic acid, undecanoic acid, and dodecanoic acid, still more preferably octanoic acid, nonanoic acid, decanoic acid, undecanoic acid, and dodecanoic acid, further preferably octanoic acid, decanoic acid, undecanoic acid, and dodecanoic acid, particularly preferably octanoic acid, decanoic acid, and undecanoic acid. Any one kind of these aliphatic monocarboxylic acids may be used alone, or two or more kinds may be used in combination.

Octanoic acid to be used as (C) in the present invention is represented by the following formula and has a CAS Registry Number 124-07-2.

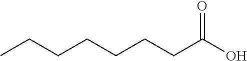

Nonanoic acid to be used as (C) in the present invention is represented by the following formula and has a CAS Registry Number 112-05-0.

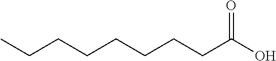

Decanoic acid to be used as (C) in the present invention is represented by the following formula and has a CAS Registry Number 334-48-5.

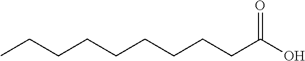

Undecanoic acid to be used as (C) in the present invention is represented by the following formula and has a CAS Registry Number 112-37-8.

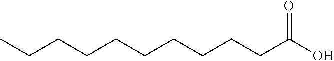

Dodecanoic acid to be used as (C) in the present invention is represented by the following formula and has a CAS Registry Number 143-07-7.

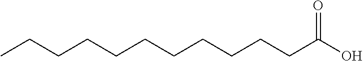

The salt of aliphatic monocarboxylic acid (e.g., decanoic acid etc.) to be used as (C) in the present invention is not particularly limited as long as it is an edible salt and does not impair the purpose of the present invention. For example, salts with alkali metals such as sodium, potassium and the like; salts with alkaline earth metals such as calcium, magnesium and the like; ammonium salt; aluminum salt; zinc salt; salts with organic amines such as triethylamine, ethanolamine, morpholine, pyrrolidine, piperidine, piperazine, dicyclohexylamine and the like; salts with basic amino acids such as arginine, lysine and the like can be mentioned. These salts may be hydrates (hydrate salts) and examples of such hydrate include 1 to 6 hydrates and the like. Any one kind of these salts may be used alone, or two or more kinds may be used in combination.

The production method of (C) (i.e., aliphatic monocarboxylic acid or a salt thereof) is not particularly limited, and one produced by a method known per se (e.g., chemical synthesis method, enzyme method, fermentation method, extraction method, etc.) or a method analogous thereto may be used. A commercially available product may be used as (C).

One embodiment of (C) (i.e., aliphatic monocarboxylic acid or a salt thereof) used in the present invention may be a chemically synthesized product produced by a chemical synthesis method or an isolated product obtained by extraction and purification from a material containing (C). Examples of the material containing (C) include natural substances such as agricultural/livestock/aquatic products and the like; fermentation products such as culture medium, bacterial cells and the like obtained by culturing microorganisms; and processed products thereof, and the like.

In the present invention, a material containing (C) may be used as it is or purified to a desired degree and used in place of a chemically synthesized product or isolated product of (C), or in addition to the chemically synthesized product or isolated product. The content of (C) in the material can be measured by gas chromatography-mass spectrometry (GC-MS).

When the enhancer of the present invention contains at least (C) as an active ingredient in addition to (A), the content of (C) in the enhancer of the present invention is preferably 0.00001 wt % or more, more preferably 0.0001 wt % or more, further preferably 0.1 wt % or more, particularly preferably 1 wt % or more, with respect to the enhancer of the present invention. In this case, the content of (C) in the enhancer of the present invention is preferably 90 wt % or less, more preferably 80 wt % or less, further preferably 70 wt % or less, particularly preferably 50 wt % or less, with respect to the enhancer of the present invention. For example, when the enhancer of the present invention contains at least (C) as an active ingredient in addition to (A), the content of (C) in the enhancer of the present invention is preferably 0.00001 to 90 wt %, more preferably 0.0001 to 80 wt %, further preferably 0.1 to 70 wt %, particularly preferably 1 to 50 wt %, with respect to the enhancer of the present invention.

In the present specification, the “content of (C)” is, for example, a content of one kind of (C) when the enhancer of the present invention contains only one kind of (C), or a total content of two or more kinds of (C) when the enhancer of the present invention contains the two or more kinds of (C). When (C) contains a salt of aliphatic monocarboxylic acid (e.g., decanoic acid, etc.), the weight of the salt is converted to the weight of a free form.

When the enhancer of the present invention contains (C) as an active ingredient in addition to (A), the weight ratio of the content of (A) and the content of (C) (A:C) in the enhancer of the present invention is preferably 1:0.25 to 750000, more preferably 1:0.5 to 500000, further preferably 1:0.6 to 300000, particularly preferably 1:0.75 to 250000, because a synergistic saltiness enhancing effect can be obtained.

When the enhancer of the present invention contains (C) in addition to (A) and (C) contains octanoic acid in one embodiment, the weight ratio of the content of (A) and the content of the octanoic acid (A: octanoic acid) in the enhancer of the present invention is preferably 1:25 to 75000, more preferably 1:50 to 50000, further preferably 1:60 to 30000, particularly preferably 1:75 to 25000, because a synergistic saltiness enhancing effect can be obtained.

When the enhancer of the present invention contains (C) in addition to (A) and (C) contains nonanoic acid in one embodiment, the weight ratio of the content of (A) and the content of the nonanoic acid (A: octanoic acid) in the enhancer of the present invention is preferably 1:0.25 to 750000, more preferably 1:0.5 to 500000, further preferably 1:0.6 to 300000, particularly preferably 1:0.75 to 250000.

When the enhancer of the present invention contains (C) in addition to (A) and (C) contains decanoic acid in one embodiment, the weight ratio of the content of (A) and the content of the decanoic acid (A: decanoic acid) in the enhancer of the present invention is preferably 1:0.25 to 750000, more preferably 1:0.5 to 500000, further preferably 1:0.6 to 300000, particularly preferably 1:0.75 to 250000, because a synergistic saltiness enhancing effect can be obtained.

When the enhancer of the present invention contains (C) in addition to (A) and (C) contains undecanoic acid in one embodiment, the weight ratio of the content of (A) and the content of the undecanoic acid (A: undecanoic acid) in the enhancer of the present invention is preferably 1:2500 to 75000, more preferably 1:5000 to 50000, further preferably 1:6000 to 30000, particularly preferably 1:7500 to 25000, because a synergistic saltiness enhancing effect can be obtained.

When the enhancer of the present invention contains (C) in addition to (A) and (C) contains dodecanoic acid in one embodiment, the weight ratio of the content of (A) and the content of the dodecanoic acid (A: dodecanoic acid) in the enhancer of the present invention is preferably 1:0.25 to 750, more preferably 1:0.5 to 500, further preferably 1:0.6 to 300, particularly preferably 1:0.75 to 250, because a synergistic saltiness enhancing effect can be obtained.

When the enhancer of the present invention contains (B) and (C) as active ingredients in addition to (A), the weight ratio of the content of (A), the content of (B) and the content of (C) (A:B:C) in the enhancer of the present invention is preferably 1:0.025 to 7500:0.25 to 750000, more preferably 1:0.05 to 5000:0.5 to 500000, further preferably 1:0.06 to 3000:0.6 to 300000, particularly preferably 1:0.075 to 2500:0.75 to 250000, because a synergistic saltiness enhancing effect can be obtained. In one embodiment, the weight ratio (A:B:C) is preferably 1:0.0025 to 7500:0.0025 to 750000, more preferably 1:0.005 to 5000:0.005 to 500000, further preferably 1:0.006 to 3000:0.006 to 300000, particularly preferably 1:0.0075 to 2500:0.0075 to 250000, because a synergistic saltiness enhancing effect can be obtained.

When the enhancer of the present invention contains (B) and (C) in addition to (A) and (C) contains octanoic acid in one embodiment, the weight ratio of the content of (A), the content of (B) and the content of the octanoic acid (A:B:octanoic acid) in the enhancer of the present invention is preferably 1:0.25 to 750:0.25 to 7.5, more preferably 1:0.5 to 500:0.5 to 5, further preferably 1:0.6 to 300:0.6 to 3, particularly preferably 1:0.75 to 250:0.75 to 2.5, because a synergistic saltiness enhancing effect can be obtained.

When the enhancer of the present invention contains (B) and (C) in addition to (A) and (C) contains nonanoic acid in one embodiment, the weight ratio of the content of (A), the content of (B) and the content of the nonanoic acid (A:B:nonanoic acid) in the enhancer of the present invention is preferably 1:0.25 to 750:0.025 to 0.75, more preferably 1:0.5 to 500:0.05 to 0.5, further preferably 1:0.6 to 300:0.06 to 0.3, particularly preferably 1:0.75 to 250:0.075 to 0.25.

When the enhancer of the present invention contains (B) and (C) in addition to (A) and (C) contains decanoic acid in one embodiment, the weight ratio of the content of (A), the content of (B) and the content of the decanoic acid (A:B:decanoic acid) in the enhancer of the present invention is preferably 1:0.0025 to 7500:0.25 to 750000, more preferably 1:0.005 to 5000:0.5 to 500000, further preferably 1:0.006 to 3000:0.6 to 300000, particularly preferably 1:0.0075 to 2500:0.75 to 250000, because a synergistic saltiness enhancing effect can be obtained.

When the enhancer of the present invention contains (B) and (C) in addition to (A) and (C) contains undecanoic acid in one embodiment, the weight ratio of the content of (A), the content of (B) and the content of the undecanoic acid (A:B:undecanoic acid) in the enhancer of the present invention is preferably 1:0.25 to 75:0.0025 to 0.075, more preferably 1:0.5 to 50:0.005 to 0.05, further preferably 1:0.6 to 30:0.006 to 0.03, particularly preferably 1:0.75 to 25:0.0075 to 0.025, because a synergistic saltiness enhancing effect can be obtained.

When the enhancer of the present invention contains (B) and (C) in addition to (A) and (C) contains dodecanoic acid in one embodiment, the weight ratio of the content of (A), the content of (B) and the content of the dodecanoic acid (A:B:dodecanoic acid) in the enhancer of the present invention is preferably 1:0.25 to 750:0.025 to 0.75, more preferably 1:0.5 to 500:0.05 to 0.5, further preferably 1:0.6 to 300:0.06 to 0.3, particularly preferably 1:0.75 to 250:0.075 to 0.25.

The enhancer of the present invention preferably further contains (B) and/or (C) in addition to (A) as active ingredients. In addition, the enhancer of the present invention more preferably further contains (B) and (C) in addition to (A) as active ingredients.

The form of the enhancer of the present invention is not particularly limited and, for example, solid (including powder, granular and the like), liquid (including slurry and the like), gel, paste and the like can be mentioned.

In one embodiment, the enhancer of the present invention may be composed of (A) alone. It may further contain, in addition to (A), a base conventionally used in the flavor field.

In addition, when the enhancer of the present invention further contains (B) and/or (C) in addition to (A), in one embodiment, the enhancer of the present invention may be any of those consisting of only (A) and (B), those consisting of only (A) and (C), and those consisting of only (A), (B) and (C). The enhancer of the present invention may further contain, in addition to (A) to (C), a base conventionally used in the field of flavor.

Examples of the base when the enhancer of the present invention is in a liquid form include water, ethanol, glycerol, propylene glycol, various animal or vegetable oils and the like.

Examples of the base when the enhancer of the present invention is in a solid form include starch, dextrin, cyclodextrin, various saccharides such as sucrose, glucose and the like, protein, peptide, sodium chloride, solid fat, silicon dioxide, and a mixture thereof, yeast fungus, various powder extracts and the like.

The enhancer of the present invention may further contain, in addition to (A) to (C), for example, excipient, pH adjuster, antioxidant, thickening stabilizer, sweetener (e.g., sugars etc.), acidulant, spice, colorant and the like as long as the purpose of the present invention is not impaired.

The enhancer of the present invention can be produced by a method conventionally used in the flavor field. The enhancer of the present invention may be subjected to, for example, a concentration treatment, a drying treatment, a decolorization treatment and the like alone or combination.

The enhancer of the present invention is preferably used to enhance a saltiness of a sodium chloride-containing food. In the present invention, the “sodium chloride-containing food” means a food that essentially contains sodium chloride. As used herein, the “food” of the sodium chloride-containing food is a concept widely encompassing those that can be ingested orally, and also includes beverages, seasonings and the like. The “sodium chloride-containing food” in the present invention includes sodium chloride itself. Further, the “saltiness enhancer” in the present invention is a concept including a composition for enhancing a saltiness.

In the present invention, the “enhancement” of a saltiness means that the saltiness is strongly felt as if the sodium chloride concentration was increased. The presence or absence and the degree of saltiness can be evaluated by a sensory evaluation by an expert panel (e.g., sensory evaluation etc. shown in Examples described later).

The enhancer of the present invention can enhance the saltiness of a sodium chloride-containing food, preferably without imparting a smell. The presence or absence smell derived from (A) to (C) can be evaluated by a sensory evaluation by an expert panel (e.g., sensory evaluation etc. shown in Examples described later).

While the sodium chloride-containing food to which the enhancer of the present invention can be added is not particularly limited, one desired to have an enhanced saltiness is preferred. For example, soup (including dried soup) such as corn soup, consomme soup (e.g., chicken, pork, beef etc.), potage, soup with egg, soup with Wakame seaweed, soup with shark fin, Chinese-style soup, curry flavor soup, Ramen noodle soup, Japanese-style clear soup, Miso soup and the like; meat processed food such as ham, sausage, Gyoza dumpling, Shumai dumpling, hamburg steak, deep-fried food, pork cutlet and the like; marine processed food such as steamed fish paste cake, tube shaped fish paste cake and the like; dairy product such as butter and the like; rice processed food such as Chinese fried rice and the like; seasoning such as savory seasoning, flavor seasoning, menu seasoning, mayonnaise, dressing, sauce (e.g., demi-glace sauce, Japanese Worcestershire-style sauce, white sauce, cheese sauce, carbonara sauce etc.) and the like; other processed food such as noodles, gratin, croquette, pickles and the like; frozen food (frozen products of the aforementioned foods (e.g., Gyoza dumpling, Shumai dumpling, Chinese fried rice, hamburg steak, deep-fried food, gratin, pork cutlet, croquette etc.), etc.) and the like can be mentioned.

In the present specification, the “savory seasoning” refers to a seasoning produced from a natural substance as a material and by a method such as extraction, decomposition, heating, fermentation, and the like. Concrete examples thereof include various meat extracts such as chicken meat extract, beef meat extract, pork meat extract, sheep meat extract and the like; various bone extracts such as chicken bone extract, beef bone extract, pork bone extract and the like; various seafood extracts such as bonito extract, mackerel extract, croaker extract, scallop extract, crab extract, shrimp extract, dried sardine extract, dried adductor extract and the like; various dried fish extracts such as dried bonito extract, dried mackerel extract, dried bullet mackerel extract and the like; various vegetable extracts such as onion extract, Chinese cabbage extract, celery extract and the like; various seaweed extracts such as kelp extract and the like; various spice extracts such as garlic extract, chili extract, pepper extract, cacao extract and the like; yeast extracts; various protein hydrolysate; various fermentation seasonings such as soy sauce, fish sauce, shrimp sauce, Miso and the like, and the like and mixtures thereof, processed product (e.g., soy sauce processed product such as Japanese noodle soup base, citrus seasoned soy sauce and the like), and the like. The “flavor seasoning” refers to a seasoning used to impart aroma, flavor and taste of a flavor material to a food, and can be produced by, for example, adding sugar, sodium chloride and the like to a savory seasoning, or the like. Specific examples of the flavor seasoning include various meat flavor seasonings such as chicken flavor seasoning, beef flavor seasoning, pork flavor seasoning and the like; various seafood flavor seasonings such as bonito flavor seasoning, dried sardine flavor seasoning, dried adductor flavor seasoning, crustacean flavor seasoning and the like; various spicy vegetable flavor seasonings; kelp flavor seasoning and the like. The “menu seasoning” refers to a seasoning suitable for cooking a particular menu (Chinese-style menu etc.). Concrete examples thereof include Chinese-style combined seasoning, combined seasoning, generic paste seasoning, seasoning for hot pot, seasoning mix for cooked rice mixed with ingredients, seasoning mix for Chinese fried rice, spice mix and the like.

The sodium chloride-containing food to which the enhancer of the present invention can be added may be provided (sold, distributed) in a form suitable for eating, or may be provided in a form that requires a predetermined processing or cooking to have a form suitable for eating. For example, the sodium chloride-containing food to which the enhancer of the present invention can be added may be provided (sold, distributed) as a concentrate or the like that requires diluting with water etc. to become a form suitable for eating.

The sodium chloride-containing food to which the enhancer of the present invention can be added may be provided, for example, as a food with health claims, a food for specified health uses, a food with nutrient function claims, a dietary supplement, a nutritional supplementary food, a health supplementary food, a food for medical use, a medical food or the like.

The content of sodium chloride (sodium chloride concentration) in the sodium chloride-containing food to which the enhancer of the present invention can be added is not particularly limited and is generally not less than 0.01 wt % based on the total weight of the sodium chloride-containing food. For effective enhancement of the saltiness, it is preferably not less than 0.03 wt %, more preferably not less than 0.05 wt %, particularly preferably not less than 0.1 wt %. The upper limit of the content is not particularly limited and may be 100 wt %. In consideration of the actual sodium chloride concentration of foods, it is preferably not more than 20 wt %, more preferably not more than 15 wt %, further preferably not more than 10 wt %, particularly preferably not more than 5 wt %, based on the total weight of the sodium chloride-containing food. For example, the content of sodium chloride (sodium chloride concentration) of a sodium chloride-containing food to which the enhancer of the present invention can be added is generally 0.01 to 100 wt %, preferably 0.01 to 20 wt %, more preferably 0.03 to 15 wt %, further preferably 0.05 to 10 wt %, particularly preferably 0.1 to 5 wt %, with respect to the total weight of the sodium chloride-containing food.

In the present invention, the “total weight of sodium chloride-containing food” refers to the total weight of the sodium chloride-containing food at the time of consumption.

The method and conditions for adding the enhancer of the present invention to the sodium chloride-containing food are not particularly limited, and can be appropriately set depending on the form of the enhancer of the present invention, the kind of the sodium chloride-containing food, and the like. The timing of addition of the enhancer of the present invention to the sodium chloride-containing food is not particularly limited, and it may be added at any time. For example, during production of food, after completion of food (e.g., immediately before eating food, during eating food, etc.) and the like can be mentioned. The enhancer of the present invention may be added to a food material before producing a sodium chloride-containing food.

In view of the effective enhancement of a saltiness, the enhancer of the present invention is preferably added to a sodium chloride-containing food such that an amount of (A) to be added to the sodium chloride-containing food falls within a particular range with respect to the total weight of the sodium chloride-containing food. Specifically, the amount of (A) to be added to a sodium chloride-containing food is preferably not less than 0.005 weight ppb, more preferably not less than 0.5 weight ppb, further preferably not less than 5 weight ppb, particularly preferably not less than 50 weight ppb, with respect to the total weight of the sodium chloride-containing food. In addition, the amount of (A) to be added to a sodium chloride-containing food is preferably 500000 weight ppb or less, more preferably 50000 weight ppb or less, particularly preferably 5000 weight ppb or less, with respect to the total weight of the sodium chloride-containing food. For example, the amount of (A) to be added to a sodium chloride-containing food is preferably 0.005 to 500000 weight ppb, more preferably 0.5 to 50000 weight ppb, further preferably 5 to 50000 weight ppb, particularly preferably 50 to 5000 weight ppb, with respect to the total weight of the sodium chloride-containing food.

When the active ingredients of the enhancer of the present invention are (A) and (B) (i.e., when the enhancer of the present invention further contains (B) in addition to (A) as active ingredients), from the aspect of effective enhancement of saltiness, the enhancer of the present invention is preferably added to a sodium chloride-containing food such that the amount of (A) and (B) to be added to the sodium chloride-containing food falls within specific ranges with respect to the total weight of the sodium chloride-containing food. Specifically, when the active ingredients of the enhancer of the present invention are (A) and (B), the amount of (A) to be added to a sodium chloride-containing food is preferably 0.0005 weight ppb or more, more preferably 0.005 weight ppb or more, particularly preferably 0.05 weight ppb or more, with respect to the total weight of the sodium chloride-containing food. In this case, the amount of (A) to be added to a sodium chloride-containing food is preferably 500000 weight ppb or less, more preferably 50000 weight ppb or less, further preferably 5 weight ppb or less, particularly preferably 0.5 weight ppb or less, with respect to the total weight of the sodium chloride-containing food. Also, in this case, the amount of (B) to be added to a sodium chloride-containing food is preferably 0.00005 weight ppb or more, more preferably 0.05 weight ppb or more, further preferably 0.3 weight ppb or more, particularly preferably 0.5 weight ppb or more, with respect to the total weight of the sodium chloride-containing food. Also, in this case, the amount of (B) to be added to a sodium chloride-containing food is preferably 500000 weight ppb or less, more preferably 50 weight ppb or less, further preferably 40 weight ppb or more, particularly preferably 30 weight ppb or less, with respect to the total weight of the sodium chloride-containing food. For example, when the active ingredients of the enhancer of the present invention are (A) and (B), the amount of (A) to be added to a sodium chloride-containing food is preferably 0.0005 to 500000 weight ppb, more preferably 0.005 to 50000 weight ppb, further preferably 0.005 to 5 weight ppb, particularly preferably 0.05 to 0.5 weight ppb, with respect to the total weight of the sodium chloride-containing food, and the amount of (B) to be added to a sodium chloride-containing food is preferably 0.00005 to 500000 weight ppb, more preferably 0.3 to 50 weight ppb, further preferably 0.05 to 50 weight ppb, particularly preferably 0.05 to 30 weight ppb or more, with respect to the total weight of the sodium chloride-containing food.

In the present specification the amount of (B) refers to, for example, the amount of the one kind of (B) when only one kind of (B) is added to the sodium chloride-containing food, and the total amount of the two or more kinds of (B) when two or more kinds of (B) are added to the sodium chloride-containing food. When (B) contains a salt of 4-methylpentanoic acid, the weight of the salt is converted to the weight of a free form.

When the active ingredients of the enhancer of the present invention are (A) and (C) (i.e., when the enhancer of the present invention further contains (C) in addition to (A) as active ingredients), from the aspect of effective enhancement of saltiness, the enhancer of the present invention is preferably added to a sodium chloride-containing food such that the amount of (A) and (C) to be added to the sodium chloride-containing food falls within specific ranges with respect to the total weight of the sodium chloride-containing food. Specifically, when the active ingredients of the enhancer of the present invention are (A) and (C), the amount of (A) to be added to a sodium chloride-containing food is preferably 0.0005 weight ppb or more, more preferably 0.005 weight ppb or more, particularly preferably 0.05 weight ppb or more, with respect to the total weight of the sodium chloride-containing food. In this case, the amount of (A) to be added to a sodium chloride-containing food is preferably 500000 weight ppb or less, more preferably 50000 weight ppb or less, further preferably 5 weight ppb or less, particularly preferably 0.5 weight ppb or less, with respect to the total weight of the sodium chloride-containing food. Also, in this case, the amount of (C) to be added to a sodium chloride-containing food is preferably 0.00005 weight ppb or more, more preferably 0.005 weight ppb or more, still more preferably 0.05 weight ppb or more, further preferably 0.5 weight ppb or more, particularly preferably 5 weight ppb or more, with respect to the total weight of the sodium chloride-containing food. Also, in this case, the amount of (C) to be added to a sodium chloride-containing food is preferably 500000 weight ppb or less, more preferably 50000 weight ppb or less, particularly preferably 30000 weight ppb or less, with respect to the total weight of the sodium chloride-containing food. For example, when the active ingredients of the enhancer of the present invention are (A) and (C), the amount of (A) to be added to a sodium chloride-containing food is preferably 0.0005 to 500000 weight ppb, more preferably 0.005 to 50000 weight ppb, further preferably 0.005 to 5 weight ppb, particularly preferably 0.05 to 0.5 weight ppb, with respect to the total weight of the sodium chloride-containing food, and the amount of (C) to be added to a sodium chloride-containing food is preferably 0.00005 to 500000 weight ppb, more preferably 0.05 to 50000 weight ppb, further preferably 0.5 to 50000 weight ppb, particularly preferably 5 to 30000, with respect to the total weight of the sodium chloride-containing food.

In the present specification, the amount of (C) refers to, for example, the amount of the one kind of (C) when only one kind of (C) is added to the sodium chloride-containing food, and the total amount of the two or more kinds of (C) when two or more kinds of (C) are added to the sodium chloride-containing food. When (C) contains a salt of aliphatic monocarboxylic acid (e.g., decanoic acid etc.), the weight of the salt is converted to the weight of a free form.

In one embodiment, when the active ingredients of the enhancer of the present invention are (A) and (C) and (C) contains octanoic acid, the amount of (A) to be added to a sodium chloride-containing food is preferably 0.0005 weight ppb or more, more preferably 0.005 weight ppb or more, particularly preferably 0.0075 weight ppb or more, with respect to the total weight of the sodium chloride-containing food. In this case, the amount of (A) to be added to a sodium chloride-containing food is preferably 500000 weight ppb or less, more preferably 50000 weight ppb or less, still more preferably 5 weight ppb or less, further preferably 0.5 weight ppb or less, particularly preferably 0.05 weight ppb or less, with respect to the total weight of the sodium chloride-containing food. Also, in this case, the amount of octanoic acid to be added to a sodium chloride-containing food is preferably 0.00005 weight ppb or more, more preferably 0.5 weight ppb or more, further preferably 0.6 weight ppb or more, particularly preferably 0.75 weight ppb or more, with respect to the total weight of the sodium chloride-containing food. Also, in this case, the amount of octanoic acid to be added to a sodium chloride-containing food is preferably 50000 weight ppb or less, more preferably 500 weight ppb or less, further preferably 300 weight ppb or less, particularly preferably 250 weight ppb or less, with respect to the total weight of the sodium chloride-containing food. For example, when the active ingredients of the enhancer of the present invention are (A) and (C) and (C) contains octanoic acid, the amount of (A) to be added to a sodium chloride-containing food is preferably 0.0005 to 500000 weight ppb, more preferably 0.005 to 5 weight ppb, further preferably 0.005 to 0.5 weight ppb, particularly preferably 0.0075 to 0.05 weight ppb, with respect to the total weight of the sodium chloride-containing food, and the amount of octanoic acid to be added to a sodium chloride-containing food is preferably 0.00005 to 50000 weight ppb, more preferably 0.5 to 500 weight ppb, further preferably 0.6 to 300 weight ppb, particularly preferably 0.75 to 250 weight ppb, with respect to the total weight of the sodium chloride-containing food.

In one embodiment, when the active ingredients of the enhancer of the present invention are (A) and (C) and (C) contains nonanoic acid, the amount of (A) to be added to a sodium chloride-containing food is preferably 0.0005 weight ppb or more, more preferably 0.005 weight ppb or more, particularly preferably 0.0075 weight ppb or more, with respect to the total weight of the sodium chloride-containing food. In this case, the amount of (A) to be added to a sodium chloride-containing food is preferably 500000 weight ppb or less, more preferably 50000 weight ppb or less, further preferably 5 weight ppb or less, particularly preferably 0.5 weight ppb or less, with respect to the total weight of the sodium chloride-containing food. Also, in this case, the amount of nonanoic acid to be added to a sodium chloride-containing food is preferably 0.00005 weight ppb or more, more preferably 0.05 weight ppb or more, further preferably 0.06 weight ppb or more, particularly preferably 0.75 weight ppb or more, with respect to the total weight of the sodium chloride-containing food. Also, in this case, the amount of nonanoic acid to be added to a sodium chloride-containing food is preferably 500000 weight ppb or less, more preferably 50000 weight ppb or less, further preferably 40000 weight ppb or less, particularly preferably 30000 weight ppb or less, with respect to the total weight of the sodium chloride-containing food. For example, when the active ingredients of the enhancer of the present invention are (A) and (C) and (C) contains nonanoic acid, the amount of (A) to be added to a sodium chloride-containing food is preferably 0.0005 to 500000 weight ppb, more preferably 0.005 to 50000 weight ppb, further preferably 0.005 to 5 weight ppb, particularly preferably 0.0075 to 0.5 weight ppb, with respect to the total weight of the sodium chloride-containing food, and the amount of nonanoic acid to be added to a sodium chloride-containing food is preferably 0.00005 to 500000 weight ppb, more preferably 0.05 to 50000 weight ppb, further preferably 0.06 to 40000 weight ppb, particularly preferably 0.75 to 30000 weight ppb, with respect to the total weight of the sodium chloride-containing food.

In one embodiment, when the active ingredients of the enhancer of the present invention are (A) and (C) and (C) contains decanoic acid, the amount of (A) to be added to a sodium chloride-containing food is preferably 0.0005 weight ppb or more, more preferably 0.005 weight ppb or more, particularly preferably 0.05 weight ppb or more, with respect to the total weight of the sodium chloride-containing food. In this case, the amount of (A) to be added to a sodium chloride-containing food is preferably 500000 weight ppb or less, more preferably 50000 weight ppb or less, further preferably 5 weight ppb or less, particularly preferably 0.5 weight ppb or less, with respect to the total weight of the sodium chloride-containing food. Also, in this case, the amount of decanoic acid to be added to a sodium chloride-containing food is preferably 0.00005 weight ppb or more, more preferably 0.05 weight ppb or more, further preferably 0.5 weight ppb or more, particularly preferably 5 weight ppb or more, with respect to the total weight of the sodium chloride-containing food. Also, in this case, the amount of decanoic acid to be added to a sodium chloride-containing food is preferably 500000 weight ppb or less, more preferably 50000 weight ppb or less, particularly preferably 30000 weight ppb or less, with respect to the total weight of the sodium chloride-containing food. For example, when the active ingredients of the enhancer of the present invention are (A) and (C) and (C) contains decanoic acid, the amount of (A) to be added to a sodium chloride-containing food is preferably 0.0005 to 500000 weight ppb, more preferably 0.005 to 50000 weight ppb, further preferably 0.005 to 5 weight ppb, particularly preferably 0.05 to 0.5 weight ppb, with respect to the total weight of the sodium chloride-containing food, and the amount of decanoic acid to be added to a sodium chloride-containing food is preferably 0.00005 to 500000 weight ppb, more preferably 0.05 to 50000 weight ppb, further preferably 0.5 to 50000 weight ppb, particularly preferably 5 to 30000 weight ppb, with respect to the total weight of the sodium chloride-containing food.

In one embodiment, when the active ingredients of the enhancer of the present invention are (A) and (C) and (C) contains undecanoic acid, the amount of (A) to be added to a sodium chloride-containing food is preferably 0.0005 weight ppb or more, more preferably 0.005 weight ppb or more, particularly preferably 0.05 weight ppb or more, with respect to the total weight of the sodium chloride-containing food. In this case, the amount of (A) to be added to a sodium chloride-containing food is preferably 500000 weight ppb or less, more preferably 50000 weight ppb or less, further preferably 5 weight ppb or less, particularly preferably 0.5 weight ppb or less, with respect to the total weight of the sodium chloride-containing food. Also, in this case, the amount of undecanoic acid to be added to a sodium chloride-containing food is preferably 0.00005 weight ppb or more, more preferably 0.05 weight ppb or more, further preferably 5 weight ppb or more, particularly preferably 500 weight ppb or more, with respect to the total weight of the sodium chloride-containing food. Also, in this case, the amount of undecanoic acid to be added to a sodium chloride-containing food is preferably 500000 weight ppb or less, more preferably 50000 weight ppb or less, particularly preferably 5000 weight ppb or less, with respect to the total weight of the sodium chloride-containing food. For example, when the active ingredients of the enhancer of the present invention are (A) and (C) and (C) contains undecanoic acid, the amount of (A) to be added to a sodium chloride-containing food is preferably 0.0005 to 500000 weight ppb, more preferably 0.005 to 50000 weight ppb, further preferably 0.005 to 5 weight ppb, particularly preferably 0.05 to 0.5 weight ppb, with respect to the total weight of the sodium chloride-containing food, and the amount of undecanoic acid to be added to a sodium chloride-containing food is preferably 0.00005 to 500000 weight ppb, more preferably 0.05 to 50000 weight ppb, further preferably 5 to 50000 weight ppb, particularly preferably 500 to 5000 weight ppb, with respect to the total weight of the sodium chloride-containing food.

In one embodiment, when the active ingredients of the enhancer of the present invention are (A) and (C) and (C) contains dodecanoic acid, the amount of (A) to be added to a sodium chloride-containing food is preferably 0.0005 weight ppb or more, more preferably 0.005 weight ppb or more, particularly preferably 0.0075 weight ppb or more, with respect to the total weight of the sodium chloride-containing food. In this case, the amount of (A) to be added to a sodium chloride-containing food is preferably 500000 weight ppb or less, more preferably 50000 weight ppb or less, still more preferably 5 weight ppb or less, further preferably 0.5 weight ppb or less, particularly preferably 0.05 weight ppb or less, with respect to the total weight of the sodium chloride-containing food. Also, in this case, the amount of dodecanoic acid to be added to a sodium chloride-containing food is preferably 0.00005 weight ppb or more, more preferably 0.005 weight ppb or more, particularly preferably 0.0075 weight ppb or more, with respect to the total weight of the sodium chloride-containing food. Also, in this case, the amount of dodecanoic acid to be added to a sodium chloride-containing food is preferably 500000 weight ppb or less, more preferably 50000 weight ppb or less, further preferably 5 weight ppb or less, particularly preferably 3 weight ppb or less, with respect to the total weight of the sodium chloride-containing food. For example, when the active ingredients of the enhancer of the present invention are (A) and (C) and (C) contains dodecanoic acid, the amount of (A) to be added to a sodium chloride-containing food is preferably 0.0005 to 500000 weight ppb, more preferably 0.005 to 5 weight ppb, further preferably 0.005 to 0.5 weight ppb, particularly preferably 0.0075 to 0.05 weight ppb, with respect to the total weight of the sodium chloride-containing food, and the amount of dodecanoic acid to be added to a sodium chloride-containing food is preferably 0.00005 to 500000 weight ppb, more preferably 0.005 to 50000 weight ppb, further preferably 0.005 to 5 weight ppb, particularly preferably 0.0075 to 3 weight ppb, with respect to the total weight of the sodium chloride-containing food.

When the active ingredients of the enhancer of the present invention are (A), (B) and (C) (i.e., when the enhancer of the present invention further contains (B) and (C) in addition to (A) as active ingredients), from the aspect of effective enhancement of saltiness, the enhancer of the present invention is preferably added to a sodium chloride-containing food such that the amount of (A), (B) and (C) to be added to the sodium chloride-containing food falls within specific ranges with respect to the total weight of the sodium chloride-containing food. Specifically, when the active ingredients of the enhancer of the present invention are (A), (B) and (C), the amount of (A) to be added to a sodium chloride-containing food is preferably 0.0005 weight ppb or more, more preferably 0.005 weight ppb or more, particularly preferably 0.05 weight ppb or more, with respect to the total weight of the sodium chloride-containing food. In this case, the amount of (A) to be added to a sodium chloride-containing food is preferably 500000 weight ppb or less, more preferably 50000 weight ppb or less, further preferably 5 weight ppb or less, particularly preferably 0.5 weight ppb or less, with respect to the total weight of the sodium chloride-containing food. Also, in this case, the amount of (B) to be added to a sodium chloride-containing food is preferably 0.00005 weight ppb or more, more preferably 0.0005 weight ppb or more, further preferably 0.003 weight ppb or more, particularly preferably 0.005 weight ppb or more, with respect to the total weight of the sodium chloride-containing food. In this case, the amount of (B) to be added to a sodium chloride-containing food is preferably 500000 weight ppb or less, more preferably 500 weight ppb or less, further preferably 400 weight ppb or less, particularly preferably 300 weight ppb or less, with respect to the total weight of the sodium chloride-containing food. Also, in this case, the amount of (C) to be added to a sodium chloride-containing food is preferably 0.00005 weight ppb or more, more preferably 0.005 weight ppb or more, further preferably 0.03 weight ppb or more, particularly preferably 0.05 weight ppb or more, with respect to the total weight of the sodium chloride-containing food. In this case, the amount of (C) to be added to a sodium chloride-containing food is preferably 500000 weight ppb or less, more preferably 50000 weight ppb or less, further preferably 40000 weight ppb or less, particularly preferably 30000 weight ppb or less, with respect to the total weight of the sodium chloride-containing food. For example, when the active ingredients of the enhancer of the present invention are (A), (B) and (C), the amount of (A) to be added to a sodium chloride-containing food is preferably 0.0005 to 500000 weight ppb, more preferably 0.005 to 50000 weight ppb, further preferably 0.005 to 5 weight ppb, particularly preferably 0.05 to 0.5 weight ppb, with respect to the total weight of the sodium chloride-containing food, the amount of (B) to be added to a sodium chloride-containing food is preferably 0.00005 to 500000 weight ppb, more preferably 0.0005 to 500 weight ppb, further preferably 0.003 to 400 weight ppb, particularly preferably 0.005 to 300 weight ppb, with respect to the total weight of the sodium chloride-containing food, and the amount of (C) to be added to a sodium chloride-containing food is preferably 0.00005 to 500000 weight ppb, more preferably 0.005 to 50000 weight ppb, further preferably 0.03 to 40000 weight ppb, particularly preferably 0.05 to 30000 weight ppb, with respect to the total weight of the sodium chloride-containing food.

In one embodiment, when the active ingredients of the enhancer of the present invention are (A), (B) and (C) and (C) contains octanoic acid, the amount of (A) to be added to a sodium chloride-containing food is preferably 0.0005 weight ppb or more, more preferably 0.005 weight ppb or more, particularly preferably 0.05 weight ppb or more, with respect to the total weight of the sodium chloride-containing food. In this case, the amount of (A) to be added to a sodium chloride-containing food is preferably 500000 weight ppb or less, more preferably 50000 weight ppb or less, further preferably 5 weight ppb or less, particularly preferably 0.5 weight ppb or less, with respect to the total weight of the sodium chloride-containing food. Also, in this case, the amount of (B) to be added to a sodium chloride-containing food is preferably 0.00005 weight ppb or more, more preferably 0.005 weight ppb or more, further preferably 0.03 weight ppb or more, particularly preferably 0.05 weight ppb or more, with respect to the total weight of the sodium chloride-containing food. In this case, the amount of (B) to be added to a sodium chloride-containing food is preferably 500000 weight ppb or less, more preferably 500 weight ppb or less, further preferably 70 weight ppb or less, particularly preferably 50 weight ppb or less, with respect to the total weight of the sodium chloride-containing food. Also, in this case, the amount of octanoic acid to be added to a sodium chloride-containing food is preferably 0.00005 weight ppb or more, more preferably 0.005 weight ppb or more, particularly preferably 0.05 weight ppb or more, with respect to the total weight of the sodium chloride-containing food. In this case, the amount of octanoic acid to be added to a sodium chloride-containing food is preferably 500000 weight ppb or less, more preferably 50 weight ppb or less, further preferably 5 weight ppb or less, particularly preferably 0.5 weight ppb or less, with respect to the total weight of the sodium chloride-containing food. For example, when the active ingredients of the enhancer of the present invention are (A), (B) and (C) and (C) contains octanoic acid, the amount of (A) to be added to a sodium chloride-containing food is preferably 0.0005 to 500000 weight ppb, more preferably 0.005 to 50000 weight ppb, further preferably 0.005 to 5 weight ppb, particularly preferably 0.05 to 0.5 weight ppb, with respect to the total weight of the sodium chloride-containing food, the amount of (B) to be added to a sodium chloride-containing food is preferably 0.00005 to 500000 weight ppb, more preferably 0.005 to 500 weight ppb, further preferably 0.03 to 70 weight ppb, particularly preferably 0.05 to 50 weight ppb, with respect to the total weight of the sodium chloride-containing food, and the amount of octanoic acid to be added to a sodium chloride-containing food is preferably 0.00005 to 500000 weight ppb, more preferably 0.005 to 50 weight ppb, further preferably 0.005 to 5 weight ppb, particularly preferably 0.05 to 0.5 weight ppb, with respect to the total weight of the sodium chloride-containing food.

In one embodiment, when the active ingredients of the enhancer of the present invention are (A), (B) and (C) and (C) contains nonanoic acid, the amount of (A) to be added to a sodium chloride-containing food is preferably 0.0005 weight ppb or more, more preferably 0.005 weight ppb or more, particularly preferably 0.05 weight ppb or more, with respect to the total weight of the sodium chloride-containing food. In this case, the amount of (A) to be added to a sodium chloride-containing food is preferably 500000 weight ppb or less, more preferably 50000 weight ppb or less, further preferably 5 weight ppb or less, particularly preferably 0.5 weight ppb or less, with respect to the total weight of the sodium chloride-containing food. Also, in this case, the amount of (B) to be added to a sodium chloride-containing food is preferably 0.00005 weight ppb or more, more preferably 0.005 weight ppb or more, further preferably 0.03 weight ppb or more, particularly preferably 0.05 weight ppb or more, with respect to the total weight of the sodium chloride-containing food. In this case, the amount of (B) to be added to a sodium chloride-containing food is preferably 500000 weight ppb or less, more preferably 500 weight ppb or less, further preferably 70 weight ppb or less, particularly preferably 50 weight ppb or less, with respect to the total weight of the sodium chloride-containing food. Also, in this case, the amount of nonanoic acid to be added to a sodium chloride-containing food is preferably 0.00005 weight ppb or more, more preferably 0.0005 weight ppb or more, particularly preferably 0.005 weight ppb or more, with respect to the total weight of the sodium chloride-containing food. In this case, the amount of nonanoic acid to be added to a sodium chloride-containing food is preferably 500000 weight ppb or less, more preferably 5 weight ppb or less, further preferably 0.5 weight ppb or less, particularly preferably 0.05 weight ppb or less, with respect to the total weight of the sodium chloride-containing food. For example, when the active ingredients of the enhancer of the present invention are (A), (B) and (C) and (C) contains nonanoic acid, the amount of (A) to be added to a sodium chloride-containing food is preferably 0.0005 to 500000 weight ppb, more preferably 0.005 to 50000 weight ppb, further preferably 0.005 to 5 weight ppb, particularly preferably 0.05 to 0.5 weight ppb, with respect to the total weight of the sodium chloride-containing food, the amount of (B) to be added to a sodium chloride-containing food is preferably 0.00005 to 500000 weight ppb, more preferably 0.005 to 500 weight ppb, further preferably 0.03 to 70 weight ppb, particularly preferably 0.05 to 50 weight ppb, with respect to the total weight of the sodium chloride-containing food, and the amount of nonanoic acid to be added to a sodium chloride-containing food is preferably 0.00005 to 500000 weight ppb, more preferably 0.0005 to 5 weight ppb, further preferably 0.0005 to 0.5 weight ppb, particularly preferably 0.005 to 0.05 weight ppb, with respect to the total weight of the sodium chloride-containing food.

In one embodiment, when the active ingredients of the enhancer of the present invention are (A), (B) and (C) and (C) contains decanoic acid, the amount of (A) to be added to a sodium chloride-containing food is preferably 0.0005 weight ppb or more, more preferably 0.005 weight ppb or more, particularly preferably 0.05 weight ppb or more, with respect to the total weight of the sodium chloride-containing food. In this case, the amount of (A) to be added to a sodium chloride-containing food is preferably 500000 weight ppb or less, more preferably 50000 weight ppb or less, further preferably 500 weight ppb or less, particularly preferably 0.5 weight ppb or less, with respect to the total weight of the sodium chloride-containing food. Also, in this case, the amount of (B) to be added to a sodium chloride-containing food is preferably 0.00005 weight ppb or more, more preferably 0.005 weight ppb or more, further preferably 0.05 weight ppb or more, particularly preferably 0.5 weight ppb or more, with respect to the total weight of the sodium chloride-containing food. In this case, the amount of (B) to be added to a sodium chloride-containing food is preferably 500000 weight ppb or less, more preferably 500 weight ppb or less, further preferably 50 weight ppb or less, particularly preferably 5 weight ppb or less, with respect to the total weight of the sodium chloride-containing food. Also, in this case, the amount of decanoic acid to be added to a sodium chloride-containing food is preferably 0.00005 weight ppb or more, more preferably 0.005 weight ppb or more, further preferably 0.03 weight ppb or more, particularly preferably 0.05 weight ppb or more, with respect to the total weight of the sodium chloride-containing food. In this case, the amount of decanoic acid to be added to a sodium chloride-containing food is preferably 500000 weight ppb or less, more preferably 70000 weight ppb or less, further preferably 50000 weight ppb or less, particularly preferably 5000 weight ppb or less, with respect to the total weight of the sodium chloride-containing food. For example, when the active ingredients of the enhancer of the present invention are (A), (B) and (C) and (C) contains decanoic acid, the amount of (A) to be added to a sodium chloride-containing food is preferably 0.0005 to 500000 weight ppb, more preferably 0.005 to 50000 weight ppb, further preferably 0.05 to 500 weight ppb, particularly preferably 0.05 to 0.5 weight ppb, with respect to the total weight of the sodium chloride-containing food, the amount of (B) to be added to a sodium chloride-containing food is preferably 0.00005 to 500000 weight ppb, more preferably 0.005 to 500 weight ppb, more preferably 0.05 to 50 weight ppb, particularly preferably 0.5 to 5 weight ppb, with respect to the total weight of the sodium chloride-containing food, and the amount of decanoic acid to be added to a sodium chloride-containing food is preferably 0.00005 to 500000 weight ppb, more preferably 0.005 to 70000 weight ppb, further preferably 0.005 to 50000 weight ppb, particularly preferably 0.05 to 50000 weight ppb, with respect to the total weight of the sodium chloride-containing food.

In one embodiment, when the active ingredients of the enhancer of the present invention are (A), (B) and (C) and (C) contains undecanoic acid, the amount of (A) to be added to a sodium chloride-containing food is preferably 0.0005 weight ppb or more, more preferably 0.005 weight ppb or more, particularly preferably 0.05 weight ppb or more, with respect to the total weight of the sodium chloride-containing food. In this case, the amount of (A) to be added to a sodium chloride-containing food is preferably 500000 weight ppb or less, more preferably 50000 weight ppb or less, further preferably 5 weight ppb or less, particularly preferably 0.5 weight ppb or less, with respect to the total weight of the sodium chloride-containing food. Also, in this case, the amount of (B) to be added to a sodium chloride-containing food is preferably 0.00005 weight ppb or more, more preferably 0.005 weight ppb or more, particularly preferably 0.05 weight ppb or more, with respect to the total weight of the sodium chloride-containing food. In this case, the amount of (B) to be added to a sodium chloride-containing food is preferably 500000 weight ppb or less, more preferably 500 weight ppb or less, further preferably 50 weight ppb or less, particularly preferably 5 weight ppb or less, with respect to the total weight of the sodium chloride-containing food. Also, in this case, the amount of undecanoic acid to be added to a sodium chloride-containing food is preferably 0.00005 weight ppb or more, more preferably 0.0001 weight ppb or more, particularly preferably 0.0005 weight ppb or more, with respect to the total weight of the sodium chloride-containing food. In this case, the amount of undecanoic acid to be added to a sodium chloride-containing food is preferably 500000 weight ppb or less, more preferably 0.5 weight ppb or less, further preferably 0.05 weight ppb or less, particularly preferably 0.005 weight ppb or less, with respect to the total weight of the sodium chloride-containing food. For example, when the active ingredients of the enhancer of the present invention are (A), (B) and (C) and (C) contains undecanoic acid, the amount of (A) to be added to a sodium chloride-containing food is preferably 0.0005 to 500000 weight ppb, more preferably 0.0005 to 50000 weight ppb, further preferably 0.005 to 5 weight ppb, particularly preferably 0.05 to 0.5 weight ppb, with respect to the total weight of the sodium chloride-containing food, the amount of (B) to be added to a sodium chloride-containing food is preferably 0.00005 to 500000 weight ppb, more preferably 0.005 to 500 weight ppb, further preferably 0.005 to 50 weight ppb, particularly preferably 0.05 to 5 weight ppb, with respect to the total weight of the sodium chloride-containing food, and the amount of undecanoic acid to be added to a sodium chloride-containing food is preferably 0.00005 to 500000 weight ppb, more preferably 0.0001 to 0.5 weight ppb, further preferably 0.0001 to 0.05 weight ppb, particularly preferably 0.0005 to 0.005 weight ppb, with respect to the total weight of the sodium chloride-containing food.

In one embodiment, when the active ingredients of the enhancer of the present invention are (A), (B) and (C) and (C) contains dodecanoic acid, the amount of (A) to be added to a sodium chloride-containing food is preferably 0.0005 weight ppb or more, more preferably 0.005 weight ppb or more, particularly preferably 0.05 weight ppb or more, with respect to the total weight of the sodium chloride-containing food. In this case, the amount of (A) to be added to a sodium chloride-containing food is preferably 500000 weight ppb or less, more preferably 50000 weight ppb or less, further preferably 5 weight ppb or less, particularly preferably 0.5 weight ppb or less, with respect to the total weight of the sodium chloride-containing food. Also, in this case, the amount of (B) to be added to a sodium chloride-containing food is preferably 0.00005 weight ppb or more, more preferably 0.005 weight ppb or more, further preferably 0.03 weight ppb or more, particularly preferably 0.05 weight ppb or more, with respect to the total weight of the sodium chloride-containing food. In this case, the amount of (B) to be added to a sodium chloride-containing food is preferably 500000 weight ppb or less, more preferably 500 weight ppb or less, further preferably 70 weight ppb or less, particularly preferably 50 weight ppb or less, with respect to the total weight of the sodium chloride-containing food. Also, in this case, the amount of dodecanoic acid to be added to a sodium chloride-containing food is preferably 0.00005 weight ppb or more, more preferably 0.0005 weight ppb or more, particularly preferably 0.005 weight ppb or more, with respect to the total weight of the sodium chloride-containing food. In this case, the amount of dodecanoic acid to be added to a sodium chloride-containing food is preferably 500000 weight ppb or less, more preferably 5 weight ppb or less, further preferably 0.5 weight ppb or less, particularly preferably 0.05 weight ppb or less, with respect to the total weight of the sodium chloride-containing food. For example, when the active ingredients of the enhancer of the present invention are (A), (B) and (C) and (C) contains dodecanoic acid, the amount of (A) to be added to a sodium chloride-containing food is preferably 0.0005 to 500000 weight ppb, more preferably 0.005 to 50000 weight ppb, further preferably 0.005 to 5 weight ppb, particularly preferably 0.05 to 0.5 weight ppb, with respect to the total weight of the sodium chloride-containing food, the amount of (B) to be added to a sodium chloride-containing food is preferably 0.00005 to 500000 weight ppb, more preferably 0.005 to 500 weight ppb, further preferably 0.03 to 70 weight ppb, particularly preferably 0.05 to 50 weight ppb, with respect to the total weight of the sodium chloride-containing food, and the amount of dodecanoic acid to be added to a sodium chloride-containing food is preferably 0.00005 to 500000 weight ppb, more preferably 0.0005 to 5 weight ppb, further preferably 0.0005 to 0.5 weight ppb, particularly preferably 0.005 to 0.05 weight ppb, with respect to the total weight of the sodium chloride-containing food.

The present invention also provides a sodium chloride-containing food containing the enhancer of the present invention (in the present specification, sometimes to be referred to as “the sodium chloride-containing food of the present invention”).

The content of the enhancer of the present invention in the sodium chloride-containing food of the present invention is not particularly limited and may be appropriately adjusted such that the amount of each of (A), (B), and (C) added to the sodium chloride-containing food falls within the aforementioned range with respect to the total weight of the sodium chloride-containing food.

The kind of the sodium chloride-containing food in the present invention is not particularly limited and one desired to have an enhanced saltiness is preferred. For example, those similar to the (aforementioned) examples recited as the food to which the enhancer of the present invention can be added can be mentioned.

### Composition of the Present Invention

According to the present invention, a composition containing (A) cyclotene, (B) 4-methylpentanoic acid or a salt thereof, and (C) aliphatic monocarboxylic acid or a salt thereof (sometimes to be referred to as “the composition of the present invention” in the present specification) is also provided.

(A) (i.e., cyclotene), (B) (i.e., 4-methylpentanoic acid or a salt thereof), and (C) (i.e., aliphatic monocarboxylic acid or a salt thereof) contained in the composition of the present invention are the same as (A), (B), and (C), respectively, contained in the enhancer of the present invention, and preferred embodiments are also the same.

The content of (A), the content of (B) and the content of (C) in the composition of the present invention are the same as the content of (A), the content of (B) and the content of (C) (mentioned above) in the enhancer of the present invention, and preferred ranges are also the same.

The composition of the present invention can be produced by a method similar to that of the enhancer of the present invention, using raw materials similar to those of the enhancer of the present invention. The form of the composition of the present invention may also be similar to that of the enhancer of the present invention.

Since the composition of the present invention effectively has a saltiness enhancing effect, it can be used in various foods containing sodium chloride, or as a seasoning or additive therefor.

In one embodiment, the composition of the present invention may be a seasoning (seasoning composition) or a food additive (food additive composition) that can be used in sodium chloride-containing foods. The kind of the sodium chloride-containing food to which the composition of the present invention can be added is not particularly limited and one desired to have an enhanced saltiness is preferred. For example, those similar to the examples recited as the sodium chloride-containing food to which the enhancer of the present invention can be added can be mentioned. The composition of the present invention can be added to sodium chloride-containing foods in the same manner as in the addition of the agent of the present invention to sodium chloride-containing foods, and the preferred embodiments are also the same.

### Production Method of the Present Invention

The present invention also provides a method for producing a sodium chloride-containing food, including adding (A) cyclotene (in the present specification, sometimes to be referred to as “the production method of the present invention”).

(A) (i.e., cyclotene) to be used in the production method of the present invention is the same as (A) contained in the enhancer of the present invention, and preferred embodiments thereof are also the same.

In the production method of the present invention, the amount of (A) to be added to a sodium chloride-containing food is preferably within a specific range relative to the total weight of the sodium chloride-containing food, from the viewpoint of effective enhancement of saltiness. Specifically, the amount of (A) to be added to a sodium chloride-containing food is in the same range as the amount of (A) to be added to a sodium chloride-containing food (described above) when the enhancer of the present invention is added to the sodium chloride-containing food, and the preferred range is also the same.

The production method of the present invention may further include, in addition to adding (A), adding (B) 4-methylpentanoic acid or a salt thereof, and/or (C) aliphatic monocarboxylic acid or a salt thereof.

(B) (i.e., 4-methylpentanoic acid or a salt thereof) and (C) (i.e., aliphatic monocarboxylic acid or a salt thereof) that can be used in the production method of the present invention are respectively the same as (B) and (C) that can be contained in the enhancer of the present invention, and preferred embodiments are also the same.

When the production method of the present invention includes adding (A) and (B), the amounts of (A) and (B) to be added to the sodium chloride-containing food are preferably within a specific range relative to the total weight of the sodium chloride-containing food, from the aspect of effective enhancement of saltiness. Specifically, the amounts of (A) and (B) to be added to the sodium chloride-containing food are in the same range as the amounts of (A) and (B) to be added to the sodium chloride-containing food (described above) when the active ingredients of the enhancer of the present invention are (A) and (B), and the preferred ranges are also the same.

When the production method of the present invention includes adding (A) and (C), the amounts of (A) and (C) to be added to the sodium chloride-containing food are preferably within a specific range relative to the total weight of the sodium chloride-containing food, from the aspect of effective enhancement of saltiness. Specifically, the amounts of (A) and (C) to be added to the sodium chloride-containing food are in the same range as the amounts of (A) and (C) to be added to the sodium chloride-containing food (described above) when the active ingredients of the enhancer of the present invention are (A) and (C), and the preferred ranges are also the same. When the production method of the present invention includes adding (A), (B) and (C), the amounts of (A), (B) and (C) to be added to the sodium chloride-containing food are preferably within a specific range relative to the total weight of the sodium chloride-containing food, from the aspect of effective enhancement of saltiness. Specifically, the amounts of (A), (B) and (C) to be added to the sodium chloride-containing food are in the same range as the amounts of (A), (B) and (C) to be added to the sodium chloride-containing food (described above) when the active ingredients of the enhancer of the present invention are (A), (B) and (C), and the preferred ranges are also the same.

When the production method of the present invention includes adding (A) and (B), the weight ratio of the amount of (A) and the amount of (B) to be added to a sodium chloride-containing food (A:B) is preferably 1:0.25 to 750, more preferably 1:0.5 to 500, further preferably 1:0.6 to 300, particularly preferably 1:0.75 to 250, because a synergistic saltiness enhancing effect can be obtained. In addition, in one embodiment, the weight ratio (A:B) is preferably 1:0.0025 to 750, more preferably 1:0.005 to 500, further preferably 1:0.006 to 300, particularly preferably 1:0.0075 to 250, because a synergistic saltiness enhancing effect can be obtained. This weight ratio is in the same range as the weight ratio (described above) between the content of (A) and the content of (B) in the enhancer of the present invention when the active ingredients of the enhancer of the present invention are (A) and (B), and the preferred range is also the same.

When the production method of the present invention includes adding (A) and (C), the weight ratio of the amount of (A) and the amount of (C) to be added to a sodium chloride-containing food (A:C) is preferably 1:0.25 to 750000, more preferably 1:0.5 to 500000, further preferably 1:0.6 to 300000, particularly preferably 1:0.75 to 250000, because a synergistic saltiness enhancing effect can be obtained. This weight ratio is in the same range as the weight ratio (described above) between the content of (A) and the content of (C) in the enhancer of the present invention when the active ingredients of the enhancer of the present invention are (A) and (C), and the preferred range is also the same.

When the production method of the present invention includes adding (A), (B) and (C), the weight ratio of the amount of (A), the amount of (B) and the amount of (C) to be added to a sodium chloride-containing food (A:B:C) is preferably 1:0.025 to 7500:0.25 to 750000, more preferably 1:0.05 to 5000:0.5 to 500000, further preferably 1:0.06 to 3000:0.6 to 300000, particularly preferably 1:0.075 to 2500:0.75 to 250000, because a synergistic saltiness enhancing effect can be obtained. In addition, in one embodiment, the weight ratio (A:B:C) is preferably 1:0.0025 to 7500:0.0025 to 750000, more preferably 1:0.005 to 5000:0.005 to 500000, further preferably 1:0.006 to 3000:0.006 to 300000, particularly preferably 1:0.0075 to 2500:0.0075 to 250000, because a synergistic saltiness enhancing effect can be obtained. This weight ratio is in the same range as the weight ratio (described above) between the content of (A), the content of (B) and the content of (C) in the enhancer of the present invention when the active ingredients of the enhancer of the present invention are (A), (B) and (C), and the preferred range is also the same.

The production method of the present invention preferably further includes adding (B) and/or (C), in addition to the addition of (A). In addition, the production method of the present invention more preferably further includes adding (B) and (C), in addition to the addition of (A).

When the production method of the present invention further includes, in addition to the addition of (A), addition of (B) and/or (C), then (A), and (B) and/or (C) may be added separately, or these may be mixed in advance before addition and the obtained mixture may be added. Alternatively, the addition of these may be performed using the enhancer of the present invention. When (A), and (B) and/or (C) are added separately, the order and interval of addition are not particularly limited. For example, when (A) and (B) are added, they may be added in the order of (A) and (B), or the reverse order, or (A) and (B) may be added simultaneously.

The production method of the present invention may appropriately include, in addition to the addition of the aforementioned (A) to (C), a processing step and a cooking step that are conventionally used in the production of foods, depending on the kind of the food to be produced and the like.

The kind of the sodium chloride-containing food obtained by the production method of the present invention is not particularly limited. One desired to have an enhanced saltiness is preferable. For example, those similar to the examples recited as the sodium chloride-containing food to which the enhancer of the present invention can be added can be mentioned.

According to the production method of the present invention, a sodium chloride-containing food with an enhanced saltiness can be produced. According to the production method of the present invention, a sodium chloride-containing food with an enhanced saltiness can be produced, preferably without imparting a smell.

### Enhancement Method of the Present Invention

The present invention also provides a method for enhancing a saltiness of a sodium chloride-containing food, including adding (A) cyclotene (in the present specification, sometimes to be referred to as “the enhancement method of the present invention”).

(A) used in the enhancement method of the present invention is the same as (A) (i.e., cyclotene) contained in the enhancer of the present invention, and preferred embodiments thereof are also the same.

In the enhancement method of the present invention, the amount of (A) to be added to a sodium chloride-containing food is preferably within a specific range relative to the total weight of the sodium chloride-containing food, from the viewpoint of effective enhancement of saltiness. Specifically, the amount of (A) to be added to a sodium chloride-containing food is in the same range as the amount of (A) to be added to a sodium chloride-containing food (described above) when the enhancer of the present invention is added to the sodium chloride-containing food, and the preferred range is also the same.

The enhancement method of the present invention may further include, in addition to adding (A), adding (B) 4-methylpentanoic acid or a salt thereof, and/or (C) aliphatic monocarboxylic acid or a salt thereof.

(B) (i.e., 4-methylpentanoic acid or a salt thereof) and (C) (i.e., aliphatic monocarboxylic acid or a salt thereof) that can be used in the enhancement method of the present invention are respectively the same as (B) and (C) that can be contained in the enhancer of the present invention, and preferred embodiments are also the same.

When the enhancement method of the present invention includes adding (A) and (B), the amounts of (A) and (B) to be added to the sodium chloride-containing food are preferably within a specific range relative to the total weight of the sodium chloride-containing food, from the aspect of effective enhancement of saltiness. Specifically, the amounts of (A) and (B) to be added to the sodium chloride-containing food are in the same range as the amounts of (A) and (B) to be added to the sodium chloride-containing food (described above) when the active ingredients of the enhancer of the present invention are (A) and (B), and the preferred ranges are also the same.

When the enhancement method of the present invention includes adding (A) and (C), the amounts of (A) and (C) to be added to the sodium chloride-containing food are preferably within a specific range relative to the total weight of the sodium chloride-containing food, from the aspect of effective enhancement of saltiness. Specifically, the amounts of (A) and (C) to be added to the sodium chloride-containing food are in the same range as the amounts of (A) and (C) to be added to the sodium chloride-containing food (described above) when the active ingredients of the enhancer of the present invention are (A) and (C), and the preferred ranges are also the same.

When the enhancement method of the present invention includes adding (A), (B) and (C), the amounts of (A), (B) and (C) to be added to the sodium chloride-containing food are preferably within a specific range relative to the total weight of the sodium chloride-containing food, from the aspect of effective enhancement of saltiness. Specifically, the amounts of (A), (B) and (C) to be added to the sodium chloride-containing food are in the same range as the amounts of (A), (B) and (C) to be added to the sodium chloride-containing food (described above) when the active ingredients of the enhancer of the present invention are (A), (B) and (C), and the preferred ranges are also the same.

When the enhancement method of the present invention includes adding (A) and (B), the weight ratio of the amount of (A) and the amount of (B) to be added to a sodium chloride-containing food is the same as the weight ratio of the amount of (A) and the amount of (B) to be added to a sodium chloride-containing food (described above) when the production method of the present invention includes adding (A) and (B), and the preferred weight ratio is also the same.

When the enhancement method of the present invention includes adding (A) and (C), the weight ratio of the amount of (A) and the amount of (C) to be added to a sodium chloride-containing food is the same as the weight ratio of the amount of (A) and the amount of (C) to be added to a sodium chloride-containing food (described above) when the production method of the present invention includes adding (A) and (C), and the preferred weight ratio is also the same.

When the enhancement method of the present invention includes adding (A), (B) and (C), the weight ratio of the amount of (A), the amount of (B) and the amount of (C) to be added to a sodium chloride-containing food is the same as the weight ratio of the amount of (A), the amount of (B) and the amount of (C) to be added to a sodium chloride-containing food (described above) when the production method of the present invention includes adding (A), (B) and (C), and the preferred weight ratio is also the same.

Unless otherwise specified, the enhancement method of the present invention can be performed similarly to the production method of the present invention, and preferred embodiments thereof are also the same.

In the enhancement method of the present invention, the method and conditions for adding (A), or (A) and (B) and/or (C) (these are sometimes to be collectively referred to as “(A) etc.” in the following) are not particularly limited, and can be appropriately set depending on the kind and the like of the sodium chloride-containing food to which these are to be added. The timing of addition of the (A) etc. to the sodium chloride-containing food is not particularly limited, and they may be added at any time. For example, during production of a sodium chloride-containing food, after completion of a sodium chloride-containing food (e.g., immediately before eating a sodium chloride-containing food, during eating a sodium chloride-containing food, etc.) and the like can be mentioned. The (A) etc. may be added to a food material before producing a sodium chloride-containing food.

The enhancement method of the present invention can enhance a saltiness of a sodium chloride-containing food. According to the enhancement method of the present invention, a saltiness of a sodium chloride-containing food can be enhanced, preferably without imparting a smell.

The kind of the sodium chloride-containing food that can have an enhanced saltiness by the enhancement method of the present invention is not particularly limited. One desired to have an enhanced saltiness is preferable. For example, those similar to the examples recited as the sodium chloride-containing food to which the enhancer of the present invention can be added can be mentioned.

Other features of the invention will become apparent in the course of the following descriptions of exemplary embodiments which are given for illustration of the invention and are not intended to be limiting thereof.

### EXAMPLES

In the present specification, “%” and “ppb” mean “wt %” and “weight ppb”, unless otherwise specified.

All of cyclotene, 4-methylpentanoic acid, decanoic acid, octanoic acid, nonanoic acid, undecanoic acid, dodecanoic acid, and propylene glycol used in the following Experimental Examples and Reference Examples are commercially available products (manufactured by Sigma-Aldrich), unless otherwise specified. In addition, the sodium chloride is also a commercially available product (manufactured by Naikai Salt Industries Co., Ltd.).

### Experimental Example 1

### Preparation of Evaluation Samples 1 to 10

Evaluation samples 1 to 10 were prepared by adding a cyclotene diluted solution (using propylene glycol as a solvent) to 1.0% sodium chloride solution to adjust the concentration of cyclotene in the sodium chloride solution as shown in the following Table 1. The amount of propylene glycol added was adjusted to be the same in all evaluation samples.

### Evaluation of Saltiness Intensity

A panel of four experts conducted a sensory evaluation of the saltiness intensity of evaluation samples 1 to 10. The sensory evaluation was performed by the four experts, who scored each evaluation sample in 0.1 point increments based on the following evaluation scale using 1.0% sodium chloride solution, 1.025% sodium chloride solution and 1.05% sodium chloride solution as reference samples, and calculated the average score of the four experts. The four experts were previously trained to have a common understanding of the following saltiness intensity evaluation scale, such as the amount of saltiness intensity change required to cause a score change of 0.1 point.

### Evaluation Scale

0.0 points: saltiness intensity equivalent to 1.0% sodium chloride solution
5.0 points: saltiness intensity equivalent to 1.025% sodium chloride solution
10.0 points: saltiness intensity equivalent to 1.05% sodium chloride solution

The results are shown in the following Table 1.

TABLE 1

| sample | cyclotene | saltiness |
|---|---|---|
| No. | concentration (ppb) | intensity |
| 1 | 0.01 | 0.6 |
| 2 | 0.1 | 1.4 |
| 3 | 1 | 3.0 |
| 4 | 10 | 4.6 |
| 5 | 100 | 5.7 |
| 6 | 200 | 5.6 |
| 7 | 500 | 5.6 |
| 8 | 1000 | 5.7 |
| 9 | 10000 | 4.1 |
| 10 | 100000 | 2.7 |

As shown in Table 1, the saltiness was enhanced in all of evaluation samples 1 to 10. In particular, the enhancement of the saltiness was remarkable in evaluation samples 3 to 9. Evaluation samples 1 to 6 were not imparted with a smell derived from cyclotene (roast odor, caramel odor). Evaluation samples 7 to 10 were imparted with a smell derived from cyclotene (two or more expert panelists sensed the smell). Evaluation samples 9 and 10 received lower scores than evaluation samples 4 to 8, which may be because evaluation samples 9 and 10 were imparted with a smell derived from cyclotene (roast odor, caramel odor), making it difficult to detect the saltiness.

### Reference Example 1

### Preparation of Evaluation Samples 11 to 17

Evaluation samples 11 to 17 were prepared by adding a 4-methylpentanoic acid diluted solution (using propylene glycol as a solvent) to 1.0% sodium chloride solution to adjust the concentration of 4-methylpentanoic acid in the sodium chloride solution as shown in the following Table 2. The amount of propylene glycol added was adjusted to be the same in all evaluation samples.

### Evaluation of Saltiness Intensity

A panel of four experts conducted a sensory evaluation of the saltiness intensity of evaluation samples 11 to 17 in the same manner as in Experimental Example 1.

The results are shown in the following Table 2.

TABLE 2

| sample | 4-methylpentanoic acid | saltiness |
|---|---|---|
| No. | concentration (ppb) | intensity |
| 11 | 0.1 | 1.4 |
| 12 | 1 | 1.9 |
| 13 | 10 | 2.2 |
| 14 | 100 | 3.6 |
| 15 | 1000 | 3.7 |
| 16 | 10000 | 4.3 |
| 17 | 100000 | 4.3 |

Evaluation samples 11 to 14 were not imparted with a smell derived from 4-methylpentanoic acid (tangy acid odor, pungent odor). Evaluation samples 15 to 17 were imparted with a smell derived from 4-methylpentanoic acid (two or more expert panelists sensed the smell).

### Reference Example 2

### Preparation of Evaluation Samples 18 to 22

Evaluation samples 18 to 22 were prepared by adding a decanoic acid diluted solution (using propylene glycol as a solvent) to 1.0% sodium chloride solution to adjust the concentration of decanoic acid in the sodium chloride solution as shown in the following Table 3. The amount of propylene glycol added was adjusted to be the same in all evaluation samples.

### Evaluation of Saltiness Intensity

A panel of four experts conducted a sensory evaluation of the saltiness intensity of evaluation samples 18 to 22 in the same manner as in Experimental Example 1.

The results are shown in the following Table 3.

TABLE 3

| sample | decanoic acid | saltiness |
|---|---|---|
| No. | concentration (ppb) | intensity |
| 18 | 1 | 1.9 |
| 19 | 10 | 2.5 |
| 20 | 100 | 2.8 |
| 21 | 1000 | 3.0 |
| 22 | 10000 | 2.9 |

Evaluation samples 18 to 22 were not imparted with a smell derived from decanoic acid (soapy smell, fatty smell).

### Experimental Example 2

### Preparation of Evaluation Samples 23 to 32

Evaluation samples 23 to 32 were prepared by adding a cyclotene diluted solution and a 4-methylpentanoic acid diluted solution (each using propylene glycol as a solvent) to 1.0% sodium chloride solution to adjust the concentration of cyclotene and 4-methylpentanoic acid in the sodium chloride solution as shown in the following Table 4. The amount of propylene glycol added was adjusted to be the same in all evaluation samples.

### Evaluation of Saltiness Intensity

A panel of four experts conducted a sensory evaluation of the saltiness intensity of evaluation samples 23 to 32 in the same manner as in Experimental Example 1.

The results are shown in the following Table 4.

TABLE 4

| | cyclotene | 4-methylpentanoic | |
|---|---|---|---|
| sample | concentration | acid concentration | saltiness |
| No. | (ppb) | (ppb) | intensity |
| 23 | 0.1 | 0.0001 | 1.9 |
| 24 | 0.1 | 0.001 | 2.2 |
| 25 | 0.1 | 0.01 | 2.8 |
| 26 | 0.1 | 0.1 | 3.1 |
| 27 | 0.1 | 1 | 3.4 |
| 28 | 0.1 | 10 | 3.8 |
| 29 | 0.1 | 100 | 4.3 |
| 30 | 0.1 | 1000 | 4.3 |
| 31 | 0.1 | 10000 | 4.3 |
| 32 | 0.1 | 100000 | 4.3 |

As shown in Table 4, the saltiness was enhanced in all of evaluation samples 23 to 32. Among them, it was confirmed that evaluation samples 26 to 28 had a synergistically enhanced saltiness. Evaluation samples 23 to 29 were not imparted with a smell derived from cyclotene (roast odor, caramel odor) and a smell derived from 4-methylpentanoic acid (tangy acid odor, pungent odor). Evaluation samples 30 to 32 were imparted with a smell derived from 4-methylpentanoic acid (two or more expert panelists sensed the smell).

### Experimental Example 3

### Preparation of Evaluation Samples 33 to 41

Evaluation samples 33 to 41 were prepared by adding a cyclotene diluted solution and a decanoic acid diluted solution (each using propylene glycol as a solvent) to 1.0% sodium chloride solution to adjust the concentration of cyclotene and decanoic acid in the sodium chloride solution as shown in the following Table 5. The amount of propylene glycol added was adjusted to be the same in all evaluation samples.

### Evaluation of Saltiness Intensity

A panel of four experts conducted a sensory evaluation of the saltiness intensity of evaluation samples 33 to 41 in the same manner as in Experimental Example 1.

The results are shown in the following Table 5.

TABLE 5

| | cyclotene | decanoic acid | |
|---|---|---|---|
| sample | concentration | concentration | saltiness |
| No. | (ppb) | (ppb) | intensity |
| 33 | 0.1 | 0.0001 | 1.8 |
| 34 | 0.1 | 0.001 | 2.0 |
| 35 | 0.1 | 0.01 | 2.2 |
| 36 | 0.1 | 0.1 | 3.0 |
| 37 | 0.1 | 1 | 3.5 |
| 38 | 0.1 | 10 | 4.1 |
| 39 | 0.1 | 100 | 4.5 |
| 40 | 0.1 | 1000 | 4.7 |
| 41 | 0.1 | 10000 | 4.6 |

As shown in Table 5, the saltiness was enhanced in all of evaluation samples 33 to 41. Among them, it was confirmed that evaluation samples 36 to 41 had a synergistically enhanced saltiness. Evaluation samples 33 to 41 were not imparted with a smell derived from cyclotene (roast odor, caramel odor) and a smell derived from decanoic acid (soapy smell, fatty smell).

### Experimental Example 4

### Preparation of Evaluation Samples 42 to 45

Evaluation samples 42 to 45 were prepared by adding a cyclotene diluted solution, a 4-methylpentanoic acid diluted solution and a decanoic acid diluted solution (each using propylene glycol as a solvent) to 1.0% sodium chloride solution to adjust the concentration of cyclotene, 4-methylpentanoic acid and decanoic acid in the sodium chloride solution as shown in the following Table 6. The amount of propylene glycol added was adjusted to be the same in all evaluation samples.

### Evaluation of Saltiness Intensity

A panel of four experts conducted a sensory evaluation of the saltiness intensity of evaluation samples 42 to 45 in the same manner as in Experimental Example 1.

The results are shown in the following Table 6.

TABLE 6

| | cyclotene | 4-methylpentanoic | decanoic | |
|---|---|---|---|---|
| | concen- | acid | acid | |
| sample | tration | concentration | concentration | saltiness |
| No. | (ppb) | (ppb) | (ppb) | intensity |
| 42 | 0.1 | 0.01 | 0.1 | 7.0 |
| 43 | 0.1 | 0.01 | 10000 | 8.1 |
| 44 | 0.1 | 100 | 0.1 | 8.3 |
| 45 | 0.1 | 100 | 10000 | 8.6 |

From the results shown in Table 6, it was confirmed that evaluation samples 42 to 45 all had a synergistically enhanced saltiness. Evaluation samples 42 to 45 were not imparted with a smell derived from cyclotene (roast odor, caramel odor), a smell derived from 4-methylpentanoic acid (tangy acid odor, pungent odor), or a smell derived from decanoic acid (soapy smell, fatty smell).

From the results of Experimental Examples 1 to 4, it was suggested that cyclotene has a saltiness enhancing action. It was also suggested that the saltiness could be enhanced more effectively by using 4-methylpentanoic acid or a salt thereof, and/or decanoic acid or a salt thereof in combination with cyclotene.

### Reference Example 3

### Preparation of Evaluation Samples 46 to 53

Evaluation samples 46 to 53 were prepared by adding a dodecanoic acid diluted solution (using propylene glycol as a solvent) to 1.0% sodium chloride solution to adjust the concentration of dodecanoic acid in the sodium chloride solution as shown in the following Table 7. The amount of propylene glycol added was adjusted to be the same in all evaluation samples.

### Preparation of Evaluation Samples 54 to 61

Evaluation samples 54 to 61 were prepared by adding an undecanoic acid diluted solution (using propylene glycol as a solvent) to 1.0% sodium chloride solution to adjust the concentration of undecanoic acid in the sodium chloride solution as shown in the following Table 8. The amount of propylene glycol added was adjusted to be the same in all evaluation samples.

### Preparation of Evaluation Samples 62 to 69

Evaluation samples 62 to 69 were prepared by adding a nonanoic acid diluted solution (using propylene glycol as a solvent) to 1.0% sodium chloride solution to adjust the concentration of nonanoic acid in the sodium chloride solution as shown in the following Table 9. The amount of propylene glycol added was adjusted to be the same in all evaluation samples.

### Preparation of Evaluation Samples 70 to 77

Evaluation samples 70 to 77 were prepared by adding an octanoic acid diluted solution (using propylene glycol as a solvent) to 1.0% sodium chloride solution to adjust the concentration of octanoic acid in the sodium chloride solution as shown in the following Table 10. The amount of propylene glycol added was adjusted to be the same in all evaluation samples.

### Evaluation of Saltiness Intensity

A panel of three experts conducted a sensory evaluation of the saltiness intensity of evaluation samples 46 to 77 in the same manner as in Experimental Example 1.

The results are shown in the following Tables 7 to 10.

TABLE 7

| | dodecanoic | |
|---|---|---|
| | acid | |
| sample | concentration | saltiness |
| No. | (ppb) | intensity |
| 46 | 0.001 | 0.1 |
| 47 | 0.01 | 1.5 |
| 48 | 0.1 | 2.2 |
| 49 | 1 | 2.7 |
| 50 | 10 | 3.0 |
| 51 | 100 | 3.3 |
| 52 | 1000 | 3.4 |
| 53 | 10000 | 2.8 |

Evaluation samples 46 to 52 were not imparted with a smell derived from dodecanoic acid (soapy smell). Evaluation sample 53 was imparted with a smell derived from dodecanoic acid (two or more expert panelists sensed the smell).

TABLE 8

| | undecanoic | |
|---|---|---|
| | acid | |
| sample | concentration | saltiness |
| No. | (ppb) | intensity |
| 54 | 0.001 | 0.8 |
| 55 | 0.01 | 2.3 |
| 56 | 0.1 | 2.6 |
| 57 | 1 | 3.0 |
| 58 | 10 | 3.3 |
| 59 | 100 | 3.6 |
| 60 | 1000 | 3.5 |
| 61 | 10000 | 3.3 |

Evaluation samples 54 to 59 were not imparted with a smell derived from undecanoic acid (wax-like smell). Evaluation samples 60 and 61 were imparted with a smell derived from undecanoic acid (two or more expert panelists sensed the smell).

TABLE 9

| | nonanoic | |
|---|---|---|
| | acid | |
| sample | concentration | saltiness |
| No. | (ppb) | intensity |
| 62 | 0.001 | 0.3 |
| 63 | 0.01 | 1.3 |
| 64 | 0.1 | 2.1 |
| 65 | 1 | 2.4 |
| 66 | 10 | 3.1 |
| 67 | 100 | 3.4 |
| 68 | 1000 | 2.7 |
| 69 | 10000 | 2.6 |

Evaluation samples 62 to 67 were not imparted with a smell derived from nonanoic acid (fat odor). Evaluation samples 68 and 69 were imparted with a smell derived from nonanoic acid (two or more expert panelists sensed the smell).

TABLE 10

| sample | octanoic acid | saltiness |
|---|---|---|
| No. | concentration (ppb) | intensity |
| 70 | 0.001 | 0.0 |
| 71 | 0.01 | 0.1 |
| 72 | 0.1 | 0.9 |
| 73 | 1 | 2.0 |
| 74 | 10 | 2.5 |
| 75 | 100 | 2.8 |
| 76 | 1000 | 3.1 |
| 77 | 10000 | 2.8 |

Evaluation samples 70 to 76 were not imparted with a smell derived from octanoic acid (goat odor). Evaluation sample 77 was imparted with a smell derived from octanoic acid (two or more expert panelists sensed the smell).

### Experimental Example 5

### Preparation of Evaluation Samples 78 to 90

Evaluation samples 78 to 90 were prepared by adding a cyclotene diluted solution and a dodecanoic acid diluted solution (each using propylene glycol as a solvent) to 1.0% sodium chloride solution to adjust the concentration of cyclotene and decanoic acid in the sodium chloride solution as shown in the following Table 11. The amount of propylene glycol added was adjusted to be the same in all evaluation samples.

### Preparation of Evaluation Samples 91 to 102

Evaluation samples 91 to 102 were prepared by adding a cyclotene diluted solution and an undecanoic acid diluted solution (each using propylene glycol as a solvent) to 1.0% sodium chloride solution to adjust the concentration of cyclotene and undecanoic acid in the sodium chloride solution as shown in the following Table 12. The amount of propylene glycol added was adjusted to be the same in all evaluation samples.

### Preparation of Evaluation Samples 103 to 115

Evaluation samples 103 to 115 were prepared by adding a cyclotene diluted solution and a nonanoic acid diluted solution (each using propylene glycol as a solvent) to 1.0% sodium chloride solution to adjust the concentration of cyclotene and nonanoic acid in the sodium chloride solution as shown in the following Table 13. The amount of propylene glycol added was adjusted to be the same in all evaluation samples.

### Preparation of Evaluation Samples 116 to 130

Evaluation samples 116 to 130 were prepared by adding a cyclotene diluted solution and an octanoic acid diluted solution (each using propylene glycol as a solvent) to 1.0% sodium chloride solution to adjust the concentration of cyclotene and octanoic acid in the sodium chloride solution as shown in the following Table 14. The amount of propylene glycol added was adjusted to be the same in all evaluation samples.

### Evaluation of Saltiness Intensity

A panel of three experts conducted a sensory evaluation of the saltiness intensity of evaluation samples 78 to 130 in the same manner as in Experimental Example 1.

The results are shown in the following Tables 11 to 14.

TABLE 11

| | | dodecanoic | |
|---|---|---|---|
| | cyclotene | acid | |
| sample | concentration | concentration | saltiness |
| No. | (ppb) | (ppb) | intensity |
| 78 | 0.01 | 0.001 | 1.8 |
| 79 | 0.01 | 0.01 | 3.0 |
| 80 | 0.01 | 0.1 | 3.5 |
| 81 | 0.01 | 1 | 3.5 |
| 82 | 0.01 | 10 | 3.4 |
| 83 | 0.1 | 0.001 | 0.6 |
| 84 | 0.1 | 0.01 | 1.3 |
| 85 | 0.1 | 0.1 | 2.6 |
| 86 | 0.1 | 1 | 3.3 |
| 87 | 0.1 | 10 | 3.8 |
| 88 | 0.1 | 100 | 4.0 |
| 89 | 0.1 | 1000 | 4.3 |
| 90 | 0.1 | 10000 | 3.9 |

TABLE 12

| | | undecanoic | |
|---|---|---|---|
| | cyclotene | acid | |
| sample | concentration | concentration | saltiness |
| No. | (ppb) | (ppb) | intensity |
| 91 | 0.01 | 0.001 | 0.5 |
| 92 | 0.01 | 0.01 | 1.5 |
| 93 | 0.01 | 0.1 | 2.2 |
| 94 | 0.01 | 1 | 2.9 |
| 95 | 0.1 | 0.001 | 2.4 |
| 96 | 0.1 | 0.01 | 2.8 |
| 97 | 0.1 | 0.1 | 3.2 |
| 98 | 0.1 | 1 | 3.6 |
| 99 | 0.1 | 10 | 4.1 |
| 100 | 0.1 | 100 | 4.8 |
| 101 | 0.1 | 1000 | 5.2 |
| 102 | 0.1 | 10000 | 4.6 |

TABLE 13

| | cyclotene | nonanoic acid | |
|---|---|---|---|
| sample | concentration | concentration | saltiness |
| No. | (ppb) | (ppb) | intensity |
| 103 | 0.01 | 0.001 | 0.2 |
| 104 | 0.01 | 0.01 | 1.3 |
| 105 | 0.01 | 0.1 | 2.7 |
| 106 | 0.01 | 1 | 3.0 |
| 107 | 0.01 | 10 | 2.8 |
| 108 | 0.1 | 0.001 | 0.2 |
| 109 | 0.1 | 0.01 | 2.0 |
| 110 | 0.1 | 0.1 | 3.0 |
| 111 | 0.1 | 1 | 3.3 |
| 112 | 0.1 | 10 | 3.6 |
| 113 | 0.1 | 100 | 3.5 |
| 114 | 0.1 | 1000 | 3.4 |
| 115 | 0.1 | 10000 | 3.2 |

TABLE 14

| | cyclotene | octanoic acid | |
|---|---|---|---|
| sample | concentration | concentration | saltiness |
| No. | (ppb) | (ppb) | intensity |
| 116 | 0.01 | 0.001 | 0.2 |
| 117 | 0.01 | 0.01 | 1.2 |
| 118 | 0.01 | 0.1 | 2.7 |
| 119 | 0.01 | 1 | 3.1 |
| 120 | 0.01 | 10 | 3.5 |
| 121 | 0.01 | 100 | 3.7 |
| 122 | 0.01 | 1000 | 3.7 |
| 123 | 0.1 | 0.001 | 1.2 |
| 124 | 0.1 | 0.01 | 2.2 |
| 125 | 0.1 | 0.1 | 2.8 |
| 126 | 0.1 | 1 | 3.0 |
| 127 | 0.1 | 10 | 3.2 |
| 128 | 0.1 | 100 | 3.4 |
| 129 | 0.1 | 1000 | 3.6 |
| 130 | 0.1 | 10000 | 3.5 |

As shown in Tables 11 to 14, the saltiness was enhanced in all of evaluation samples 78 to 130. In particular, it was confirmed that evaluation samples 79 to 81, 101 and 119 to 121 all had a synergistically enhanced saltiness.

In addition, all of evaluation samples 78 to 89, 91 to 101, 103 to 114 and 116 to 130 were not imparted with a smell derived from cyclotene (roast odor, caramel odor), a smell derived from dodecanoic acid (soapy smell), a smell derived from undecanoic acid (wax-like smell), a smell derived from nonanoic acid (fat odor) or a smell derived from octanoic acid (goat odor). Evaluation sample 90 was imparted with a smell derived from dodecanoic acid, evaluation sample 102 was imparted with a smell derived from undecanoic acid, and evaluation sample 115 was imparted with a smell derived from nonanoic acid (two or more expert panelists sensed the smell).

### Experimental Example 6

### Preparation of Evaluation Samples 131 to 133

Evaluation samples 131 to 133 were prepared by adding a cyclotene diluted solution, a 4-methylpentanoic acid diluted solution and a dodecanoic acid diluted solution (using propylene glycol as a solvent) to 1.0% sodium chloride solution to adjust the concentration of cyclotene, 4-methylpentanoic acid and dodecanoic acid in the sodium chloride solution as shown in the following Table 15. The amount of propylene glycol added was adjusted to be the same in all evaluation samples.

### Preparation of Evaluation Samples 134 to 136

Evaluation samples 134 to 136 were prepared by adding a cyclotene diluted solution, a 4-methylpentanoic acid diluted solution and an undecanoic acid diluted solution (using propylene glycol as a solvent) to 1.0% sodium chloride solution to adjust the concentration of cyclotene, 4-methylpentanoic acid and undecanoic acid in the sodium chloride solution as shown in the following Table 16. The amount of propylene glycol added was adjusted to be the same in all evaluation samples.

### Preparation of Evaluation Samples 137 to 139

Evaluation samples 137 to 139 were prepared by adding a cyclotene diluted solution, a 4-methylpentanoic acid diluted solution and a nonanoic acid diluted solution (using propylene glycol as a solvent) to 1.0% sodium chloride solution to adjust the concentration of cyclotene, 4-methylpentanoic acid and nonanoic acid in the sodium chloride solution as shown in the following Table 17. The amount of propylene glycol added was adjusted to be the same in all evaluation samples.

### Preparation of Evaluation Samples 140 to 142

Evaluation samples 140 to 142 were prepared by adding a cyclotene diluted solution, a 4-methylpentanoic acid diluted solution and an octanoic acid diluted solution (using propylene glycol as a solvent) to 1.0% sodium chloride solution to adjust the concentration of cyclotene, 4-methylpentanoic acid and octanoic acid in the sodium chloride solution as shown in the following Table 18. The amount of propylene glycol added was adjusted to be the same in all evaluation samples.

### Evaluation of Saltiness Intensity

A panel of three experts conducted a sensory evaluation of the saltiness intensity of evaluation samples 131 to 142 in the same manner as in Experimental Example 1.

The results are shown in the following Tables 15 to 18.

TABLE 15

| | cyclotene | 4-methylpentanoic | dodecanoic | |
|---|---|---|---|---|
| | concen- | acid | acid | |
| sample | tration | concentration | concentration | saltiness |
| No. | (ppb) | (ppb) | (ppb) | intensity |
| 131 | 0.1 | 0.1 | 0.01 | 3.9 |
| 132 | 0.1 | 1 | 0.01 | 4.8 |
| 133 | 0.1 | 10 | 0.01 | 4.9 |

TABLE 16

| | cyclotene | 4-methylpentanoic | undecanoic | |
|---|---|---|---|---|
| | concen- | acid | acid | |
| sample | tration | concentration | concentration | saltiness |
| No. | (ppb) | (ppb) | (ppb) | intensity |
| 134 | 0.1 | 0.1 | 0.001 | 3.8 |
| 135 | 0.1 | 1 | 0.001 | 4.5 |
| 136 | 0.1 | 10 | 0.001 | 4.3 |

TABLE 17

| | cyclotene | 4-methylpentanoic | nonanoic | |
|---|---|---|---|---|
| | concen- | acid | acid | |
| sample | tration | concentration | concentration | saltiness |
| No. | (ppb) | (ppb) | (ppb) | intensity |
| 137 | 0.1 | 0.1 | 0.01 | 3.2 |
| 138 | 0.1 | 1 | 0.01 | 3.9 |
| 139 | 0.1 | 10 | 0.01 | 4.8 |

TABLE 18

| | cyclotene | 4-methyl-pentanoic | octanoic | |
|---|---|---|---|---|
| | concen- | acid | acid | |
| sample | tration | concentration | concentration | saltiness |
| No. | (ppb) | (ppb) | (ppb) | intensity |
| 140 | 0.1 | 0.1 | 0.1 | 3.9 |
| 141 | 0.1 | 1 | 0.1 | 4.7 |
| 142 | 0.1 | 10 | 0.1 | 5.1 |

As shown in Tables 15 to 18, the saltiness was enhanced in all of evaluation samples 131 to 142. In particular, it was confirmed that evaluation samples 134, 135 and 140 to 142 had a synergistically enhanced saltiness.

In addition, all of evaluation samples 131 to 142 were not imparted with a smell derived from cyclotene (roast odor, caramel odor), a smell derived from 4-methylpentanoic acid (tangy acid odor, pungent odor), a smell derived from dodecanoic acid (soapy smell), a smell derived from undecanoic acid (wax-like smell), a smell derived from nonanoic acid (fat odor) or a smell derived from octanoic acid (goat odor).

### Experimental Example 7

The concentrated soup included with commercially available instant ramen (manufactured by Toyo Suisan Kaisha Ltd., product name “MARUCHAN SEIMEN UMASHIOAJI”) was diluted with hot water according to the instructions on the product package to prepare soup (hereinafter referred to as “product direction soup”).

The product direction soup was diluted 1.2 times with hot water. To the resulting diluted product (hereinafter referred to as “1.2-fold diluted product”) were added a cyclotene diluted solution, a 4-methylpentanoic acid diluted solution and a decanoic acid diluted solution (each using propylene glycol as a solvent) to adjust the concentrations of cyclotene, 4-methylpentanoic acid, and decanoic acid in the diluted product as shown in the following Table 19, whereby evaluation samples 143 to 148 were prepared. The amount of propylene glycol added was adjusted to be the same in all evaluation samples.

### Evaluation of Saltiness Intensity

A panel of three experts conducted a sensory evaluation of the saltiness intensity of evaluation samples 143 to 148. The sensory evaluation was performed by the three experts, who scored each evaluation sample in 0.01 point increments based on the following evaluation scale using the 1.2-fold diluted product and a 1.2-fold diluted product added with a given amount of sodium chloride as reference samples, and calculated the average score of the three experts. The three experts were previously trained to have a common understanding of the following saltiness intensity evaluation scale, such as the amount of saltiness intensity change required to cause a score change of 0.01 point.

### Evaluation Scale

0.8 points: same saltiness intensity as 1.2-fold diluted soup
0.9 points: same saltiness intensity as that when sodium chloride in an amount affording a sodium chloride concentration equivalent to that of product direction soup diluted 1.1-fold with hot water is added to a 1.2-fold diluted product
1.0 points: same saltiness intensity as that when sodium chloride in an amount affording a sodium chloride concentration equivalent to that of product direction soup is added to a 1.2-fold diluted product

The results are shown in the following Table 19.

TABLE 19

| | cyclotene | 4-methylpentanoic | decanoic | |
|---|---|---|---|---|
| | concen- | acid | acid | |
| sample | tration | concentration | concentration | saltiness |
| No. | (ppb) | (ppb) | (ppb) | intensity |
| 143 | 100 | | | 0.81 |
| 144 | | | 1000 | 0.84 |
| 145 | | 1 | | 0.84 |
| 146 | 100 | | 1000 | 0.88 |
| 147 | 100 | 1 | | 0.89 |
| 148 | 100 | 1 | 1000 | 0.94 |

As shown in Table 19, the saltiness was enhanced in all of evaluation samples 143 to 148. In particular, it was confirmed that evaluation samples 146 to 148 had a synergistically enhanced saltiness.

In addition, all of evaluation samples 146 to 148 were not imparted with a smell derived from cyclotene (roast odor, caramel odor), a smell derived from 4-methylpentanoic acid (tangy acid odor, pungent odor) or a smell derived from decanoic acid (soapy smell, fatty smell).

### INDUSTRIAL APPLICABILITY

According to the present invention, a saltiness enhancer is provided. The enhancer of the present invention preferably can enhance the saltiness of a sodium chloride-containing food. The enhancer of the present invention preferably can enhance the saltiness of a sodium chloride-containing food without imparting a smell.

In addition, according to the present invention, a method for enhancing the saltiness of a sodium chloride-containing food is provided. The enhancement method of the present invention can enhance the saltiness of a sodium chloride-containing food. The enhancement method of the present invention preferably can enhance the saltiness of a sodium chloride-containing food without imparting a smell.

In addition, according to the present invention, a method for producing a sodium chloride-containing food is provided.

The production method of the present invention can produce a sodium chloride-containing food with an enhanced saltiness. The production method of the present invention preferably can produce a sodium chloride-containing food with an enhanced saltiness without imparting a smell.

Where a numerical limit or range is stated herein, the endpoints are included. Also, all values and subranges within a numerical limit or range are specifically included as if explicitly written out.

As used herein the words “a” and “an” and the like carry the meaning of “one or more.”

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A saltiness enhancer comprising (A) cyclotene as an active ingredient.

2. The enhancer according to claim 1, wherein the enhancer is added to a sodium chloride-containing food such that the amount of (A) to be added to the sodium chloride-containing food is 0.005 to 500000 weight ppb with respect to the total weight of the sodium chloride-containing food.

3. The enhancer according to claim 1, further comprising (B) 4-methylpentanoic acid or a salt thereof, and/or (C) at least one aliphatic monocarboxylic acid having a carbon atom number of 4 to 16 or a salt thereof as the active ingredient.

4. The enhancer according to claim 3, wherein (C) is at least one member selected from the group consisting of octanoic acid, nonanoic acid, decanoic acid, undecanoic acid, dodecanoic acid and salts thereof.

5. The enhancer according to claim 3, wherein (C) is at least one member selected from the group consisting of octanoic acid, decanoic acid, undecanoic acid and salts thereof.

6. The enhancer according to claim 3, wherein (C) is decanoic acid or a salt thereof.

7. The enhancer according to claim 3, wherein the active ingredients are (A) and (B),
the enhancer is added to a sodium chloride-containing food such that the amount of (A) to be added to the sodium chloride-containing food is 0.0005 to 500000 weight ppb with respect to the total weight of the sodium chloride-containing food, and
the amount of (B) to be added to the sodium chloride-containing food is 0.00005 to 500000 weight ppb with respect to the total weight of the sodium chloride-containing food.

8. The enhancer according to claim 3, wherein the active ingredients are (A) and (C),
the enhancer is added to a sodium chloride-containing food such that the amount of (A) to be added to the sodium chloride-containing food is 0.0005 to 500000 weight ppb with respect to the total weight of the sodium chloride-containing food, and
the amount of (C) to be added to the sodium chloride-containing food is 0.00005 to 500000 weight ppb with respect to the total weight of the sodium chloride-containing food.

9. The enhancer according to claim 3, wherein the active ingredients are (A), (B) and (C),
the enhancer is added to a sodium chloride-containing food such that the amount of (A) to be added to the sodium chloride-containing food is 0.0005 to 500000 weight ppb with respect to the total weight of the sodium chloride-containing food,
the amount of (B) to be added to the sodium chloride-containing food is 0.00005 to 500000 weight ppb with respect to the total weight of the sodium chloride-containing food, and
the amount of (C) to be added to the sodium chloride-containing food is 0.00005 to 500000 weight ppb with respect to the total weight of the sodium chloride-containing food.

10. A sodium chloride-containing food comprising the enhancer according to claim 1.

11. A method for producing a sodium chloride-containing food, comprising adding (A) cyclotene.

12. The production method according to claim 11, wherein the amount of (A) to be added to the sodium chloride-containing food is 0.005 to 500000 weight ppb with respect to the total weight of the sodium chloride-containing food.

13. The production method according to claim 11, further comprising adding (B) 4-methylpentanoic acid or a salt thereof, and/or (C) at least one aliphatic monocarboxylic acid having a carbon atom number of 4 to 16 or a salt thereof.

14. The production method according to claim 13, wherein (C) is at least one member selected from the group consisting of octanoic acid, nonanoic acid, decanoic acid, undecanoic acid, dodecanoic acid and salts thereof.

15. The production method according to claim 13, wherein (C) is at least one member selected from the group consisting of octanoic acid, decanoic acid, undecanoic acid and salts thereof.

16. The production method according to claim 13, wherein (C) is decanoic acid or a salt thereof.

17. The production method according to claim 13, comprising adding (A) and (B), wherein
the amount of (A) to be added to the sodium chloride-containing food is 0.0005 to 500000 weight ppb with respect to the total weight of the sodium chloride-containing food, and
the amount of (B) to be added to the sodium chloride-containing food is 0.00005 to 500000 weight ppb with respect to the total weight of the sodium chloride-containing food.

18. The production method according to claim 13, comprising adding (A) and (C), wherein
the amount of (A) to be added to the sodium chloride-containing food is 0.0005 to 500000 weight ppb with respect to the total weight of the sodium chloride-containing food, and
the amount of (C) to be added to the sodium chloride-containing food is 0.00005 to 500000 weight ppb with respect to the total weight of the sodium chloride-containing food.

19. The production method according to claim 13, comprising adding (A), (B) and (C), wherein
the amount of (A) to be added to the sodium chloride-containing food is 0.0005 to 500000 weight ppb with respect to the total weight of the sodium chloride-containing food, and
the amount of (B) to be added to the sodium chloride-containing food is 0.00005 to 500000 weight ppb with respect to the total weight of the sodium chloride-containing food, and
the amount of (C) to be added to the sodium chloride-containing food is 0.00005 to 500000 weight ppb with respect to the total weight of the sodium chloride-containing food.

20. A method for enhancing a saltiness of a sodium chloride-containing food, comprising adding (A) cyclotene.

21. The enhancement method according to claim 20, wherein the amount of (A) to be added to the sodium chloride-containing food is 0.005 to 500000 weight ppb with respect to the total weight of the sodium chloride-containing food.

22. The enhancement method according to claim 20, further comprising adding (B) 4-methylpentanoic acid or a salt thereof, and/or (C) at least one aliphatic monocarboxylic acid having a carbon atom number of 4 to 16 or a salt thereof.

23. The enhancement method according to claim 22, wherein (C) is at least one member selected from the group consisting of octanoic acid, nonanoic acid, decanoic acid, undecanoic acid, dodecanoic acid and salts thereof.

24. The enhancement method according to claim 22, wherein (C) is at least one member selected from the group consisting of octanoic acid, decanoic acid, undecanoic acid and salts thereof.

25. The enhancement method according to claim 22, wherein (C) is decanoic acid or a salt thereof.

26. The enhancement method according to claim 22, comprising adding (A) and (B), wherein
the amount of (A) to be added to the sodium chloride-containing food is 0.0005 to 500000 weight ppb with respect to the total weight of the sodium chloride-containing food, and
the amount of (B) to be added to the sodium chloride-containing food is 0.00005 to 500000 weight ppb with respect to the total weight of the sodium chloride-containing food.

27. The enhancement method according to claim 22, comprising adding (A) and (C), wherein
the amount of (A) to be added to the sodium chloride-containing food is 0.0005 to 500000 weight ppb with respect to the total weight of the sodium chloride-containing food, and
the amount of (C) to be added to the sodium chloride-containing food is 0.00005 to 500000 weight ppb with respect to the total weight of the sodium chloride-containing food.

28. The enhancement method according to claim 22, comprising adding (A), (B) and (C), wherein
the amount of (A) to be added to the sodium chloride-containing food is 0.0005 to 500000 weight ppb with respect to the total weight of the sodium chloride-containing food, and
the amount of (B) to be added to the sodium chloride-containing food is 0.00005 to 500000 weight ppb with respect to the total weight of the sodium chloride-containing food, and
the amount of (C) to be added to the sodium chloride-containing food is 0.00005 to 500000 weight ppb with respect to the total weight of the sodium chloride-containing food.

29. A composition comprising (A) cyclotene, (B) 4-methylpentanoic acid or a salt thereof, and (C) at least one aliphatic monocarboxylic acid having a carbon atom number of 4 to 16 or a salt thereof.

30. The composition according to claim 29, wherein (C) is at least one member selected from the group consisting of octanoic acid, nonanoic acid, decanoic acid, undecanoic acid, dodecanoic acid and salts thereof.

31. The composition according to claim 29, wherein (C) is at least one member selected from the group consisting of octanoic acid, decanoic acid, undecanoic acid and salts thereof.

32. The composition according to claim 29, wherein
the content of (A) in the composition is 0.0001 to 99.9 wt % with respect to the composition,
the content of (B) in the composition is 0.00001 to 90 wt % with respect to the composition, and
the content of (C) in the composition is 0.00001 to 90 wt& with respect to the composition.

33. The composition according to claim 29, wherein a weight ratio of the content of (A), the content of (B), and the content of (C) (A:B:C) is 1:0.0025 to 7500:0.0025 to 750000.
